(19) United States
(12) Patent Application Publication
(10) Pub. No.: US 2026/0161266 A1
(43) Pub. Date: Jun. 11, 2026

(54) DISPLAY CONTROL SYSTEM, DISPLAY CONTROL METHOD, AND INFORMATION STORAGE MEDIUM

(71) Applicant: RAKUTEN GROUP, INC., Tokyo (JP)

(72) Inventors: Choyeon KIM, Tokyo (JP); Sijingzi YANG, Tokyo (JP); Yui KASAHARA, Tokyo (JP)

(21) Appl. No.: 19/178,863

(22) Filed: Apr. 14, 2025

(30) Foreign Application Priority Data
Apr. 26, 2024 (JP) 2024-072542

(51) Int. Cl. G06F 3/0482

(52) U.S. Cl. CPC G06F 3/0482

(57) ABSTRACT

A display control system includes at least one processor causing a user terminal, which stores an application for providing a plurality of functions to a user, to display an instruction screen including an instruction part for the user to instruct display of a list screen concerning a list of the plurality of functions, when the instruction part has been selected, causing the user terminal to display the list screen, when the function with which a message to the user is correlated is present among the plurality of functions, causing the user terminal to display the list screen in which the message is correlated with the function, and, when the function with which the message is correlated is present among the plurality of functions, causing the user terminal to display the instruction screen in which notification concerning the message is correlated with the instruction part.

### CROSS-REFERENCE TO RELATED APPLICATION

The present application claims priority from Japanese patent application JP2024-072542 filed on Apr. 26, 2024, the disclosures of which are hereby incorporated by reference into this application.

### BACKGROUND OF THE INVENTION

### 1. Field of the Invention

The present disclosure relates to a display control system, a display control method, and an information storage medium.

### 2. Description of the Related Art

There has been known an application for providing a plurality of functions to a user. For example, Patent Literature 1 (JP 2023-120038 A) describes a settlement service providing device that causes a top screen of a settlement application for providing a plurality of functions concerning a settlement service to a user to display, together with a code image used in settlement, icons for the user to select each of the plurality of functions. In Non-Patent Literature 1 (“Icon are not displayed on the home screen”), Internet, searched on Mar. 26, 2024, online, https://paypay.ne.jp/help/c0149/), when the user selects all the “icons” displayed on the top screen of the settlement application described in Patent Literature 1 (JP 2023-120038 A), a list screen concerning a list of all the functions is displayed.

### SUMMARY OF THE INVENTION

However, in the techniques described in Patent Literature 1 and Non-Patent Literature 1, even if functions with which messages to the user are correlated are displayed on the list screen, the user cannot notice the presence of the message from the top screen. Therefore, the convenience of the user cannot be sufficiently improved. This point is not limited to the settlement application described in Patent Literature 1 and is the same for other applications. For this reason, in the related art, the convenience of the user cannot be sufficiently improved.

An object of the present disclosure is to improve the convenience of a user.

A display control system according to the present disclosure includes at least one processor: causing a user terminal, which stores an application for providing a plurality of functions to a user, to display an instruction screen including an instruction part for the user to instruct to display a list screen concerning a list of the plurality of functions; when the instruction part has been selected, causing the user terminal to display the list screen; when the function with which a message to the user is correlated is present among the plurality of functions, causing the user terminal to display the list screen on which the message is correlated with the function; and, when the function with which the message is correlated is present among the plurality of functions, causing the user terminal to display the instruction screen on which a notification concerning the message is correlated with the instruction part.

### BRIEF DESCRIPTION OF THE DRAWINGS

FIG. 1 is a diagram illustrating an example of a hardware configuration of a display control system;

FIG. 2 is a diagram illustrating a screen example of an application;

FIG. 3 is a diagram illustrating a screen example of the application in the case in which a function with which a message is correlated is present;

FIG. 4 is a diagram illustrating an example of functions implemented by the display control system;

FIG. 5 is a diagram illustrating an example of a database;

FIG. 6 is a diagram illustrating an example of processing executed by the display control system;

FIG. 7 is a diagram illustrating an example of functions implemented in a modification;

FIG. 8 is a diagram illustrating a screen example of an application in a modification 1;

FIG. 9 is a diagram illustrating a screen example of an application in a modification 2;

FIG. 10 is a diagram illustrating a screen example of an application in a modification 7;

FIG. 11 is a diagram illustrating a screen example of the application in the modification 7;

FIG. 12 is a diagram illustrating a screen example of an application in a modification 8;

FIG. 13 is a diagram illustrating a screen example of an application in a modification 9;

FIG. 14 is a diagram illustrating a screen example of an application in a modification 10;

FIG. 15 is a diagram illustrating a screen example of an application in a modification 13; and

FIG. 16 is a diagram illustrating a screen example of an application in a modification 15.

### DETAILED DESCRIPTION OF THE INVENTION

### [1. Hardware Configuration of a Display Control System]

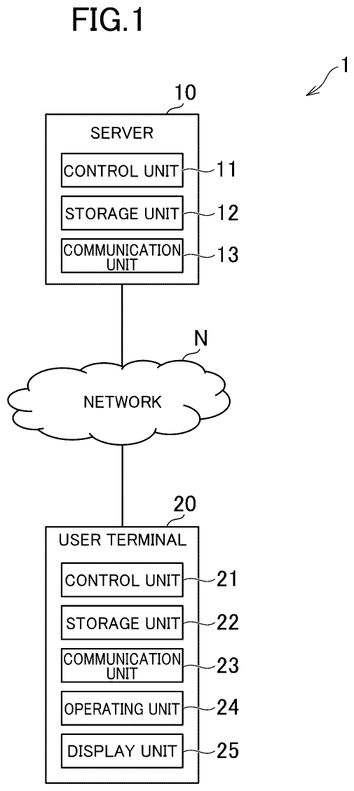

An example of a display control system, a display control method, and a program according to an embodiment of the present disclosure are explained. FIG. 1 is a diagram illustrating an example of a hardware configuration of the display control system. For example, a display control system 1 includes a server 10 and a user terminal 20. Each of the server 10 and the user terminal 20 is connected to a network N such as the Internet or a LAN. In FIG. 1, one server 10 and one user terminal 20 are illustrated. However, at least one of the server 10 and the user terminal 20 may be present in plurality.

The server 10 is a server computer that provides a predetermined service to a user. In the present embodiment, an example is explained in which a settlement service is equivalent to the predetermined service. For this reason, the settlement service can be replaced with the predetermined service. The predetermined service may be any service. The predetermined service is not limited to the settlement service. For example, the predetermined service may be an electronic commerce service, a travel reservation service, a financial service, a communication service, a video distribution service, an SNS, or another service.

For example, the server 10 includes a control unit 11, a storage unit 12, and a communication unit 13. The control unit 11 includes at least one processor. The storage unit 12 includes at least one of a volatile memory such as a RAM and a nonvolatile memory such as a flash memory. The communication unit 13 includes at least one of a communication interface for wired communication and a communication interface for wireless communication.

The user terminal 20 is a computer of the user. For example, the user terminal 20 is a smartphone, a tablet terminal, a personal computer, or a wearable terminal. The user terminal 20 includes a control unit 21, a storage unit 22, a communication unit 23, an operation unit 24, and a display unit 25. Hardware configurations of the control unit 21, the storage unit 22, and the communication unit 23 may be respectively the same as hardware configurations of the control unit 11, the storage unit 12, and the communication unit 13. The operation unit 24 is an input device such as a touch panel or a mouse. The display unit 25 is a display such as a liquid crystal display or an organic EL display.

Note that programs stored in the storage units 12 and 22 may be supplied to the server 10 or the user terminal 20 via the network N. At least one of a reading unit (for example, a memory card slot) that reads a computer-readable information storage medium and an input and output unit (for example, a USB port) for inputting and outputting data from and to external equipment may be included in the server 10 or the user terminal 20. For example, a program stored in the information storage medium may be supplied to the server 10 or the user terminal 20 via at least one of the reading unit and the input and output unit.

The display control system 1 only has to include at least one computer. The computer included in the display control system 1 is not limited to the example illustrated in FIG. 1. For example, the display control system 1 may include only the server 10. In this case, the user terminal 20 is present on the outside of the display control system 1. For example, the display control system 1 may include the server 10 and another computer not illustrated in FIG. 1. The display control system 1 may include only the user terminal 20. In this case, the server 10 is present on the outside of the display control system 1. For example, the display control system 1 may include the user terminal 20 and another computer not illustrated in FIG. 1.

### [2. Overview of the Display Control System]

In the present embodiment, the user uses a predetermined service, an example of which is a settlement service, from an application stored in the user terminal 20. The application is a type of a program. For example, when the user terminal 20 is a smartphone, the application is sometimes called smartphone application. The application may be an application classified into a so-called super application or may be an application not particularly classified into the super application. When the user operates the user terminal 20 and selects the application, the user terminal 20 causes the display unit 25 to display various screens of the application.

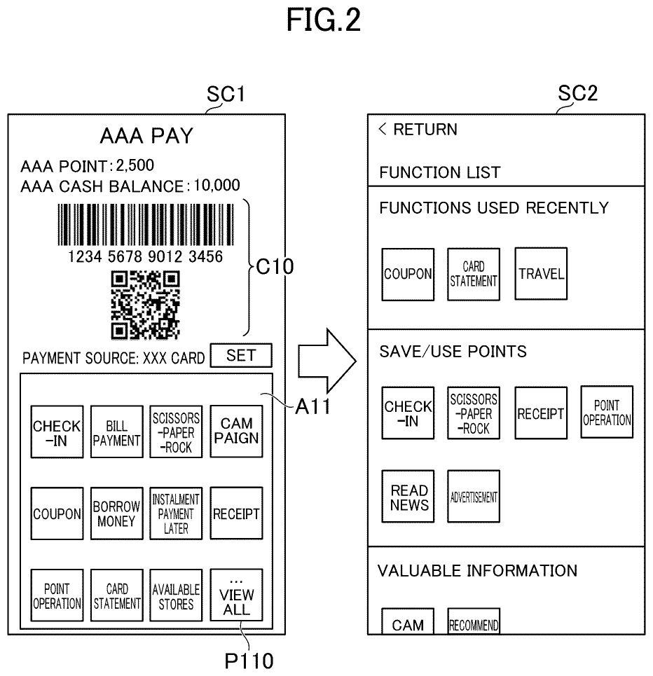

FIG. 2 is a diagram illustrating a screen example of the application. As illustrated on the left side of FIG. 2, when the application starts, the user terminal 20 causes the display unit 25 to display an instruction screen SC1 equivalent to a top page of the application. For example, the instruction screen SC1 includes a code C10 generated based on a code ID capable of temporarily identifying the user. The code C10 is at least one of a barcode and a two-dimensional code. When the code C10 is read by a terminal of a store, settlement is executed based on the code ID acquired from the code C10. Processing for the settlement may be publicly-known processing.

Note that the settlement is not limited to a type of reading the code C10 with the terminal of the store. The settlement may be any type. For example, the settlement may be a type of reading, with the user terminal 20, a code displayed on the terminal of the store, a type of reading, with the user terminal 20, a code posted in the store, a type completed only by operation on the user terminal 20, a type of using an IC chip of the user terminal 20, online settlement (for example, account settlement in which an account of the user is used or ID settlement in which an ID of the user is used), carrier settlement that is settlement of a carrier used by the user terminal 20, or another type.

In the present embodiment, the application provides a plurality of functions to the user. The functions are information processing to be executed by the application or another program. The functions can also be referred to as services. For example, the functions may be processing by mini application called from the super application, processing by an application not classified into the mini application, processing for display of a screen indicated by a link, processing for display by Web view, or processing for display of a screen on a browser. When the application itself has some function (in the present embodiment, a function for settlement, charge, or the like), each of the plurality of functions provided by the application may be a function relating to the function of the application itself or may be a function not relating to the function of the application itself.

For example, the instruction screen SC1 includes a display region A11 in which icons for the user to use some of all the functions provided by the application are arranged. The icons of the functions may have any appearances. The icons of the functions may show character strings indicating names of the functions or may show figures corresponding to the functions. By selecting an icon of a certain function, the user can use the function. In the present embodiment, an example is explained in which the instruction screen SC1 includes another region (for example, a region where the code C10 is displayed) as well other than the display region A11. However, the instruction screen SC1 may include only the display region A11.

In an example illustrated on the left side of FIG. 2, respective icons of a check-in function for the user to check in a predetermined place, a bill payment function for the user to make payment for a bill, a scissors-paper-rock function for the user to acquire a privilege by means of scissors-paper-rock, a campaign function for the user to make entry in a campaign, a coupon function for the user to acquire a coupon, a cashing function for the user to perform cashing, an instalment payment function for the user to apply for payment by instalment, a receipt function for the user to manage receipts, a point operation function for the user to operate points, a card statement function for the user to check a statement of a credit card, and a store check function for the user to check a store are displayed in the display region A11.

In the present embodiment, a function of not displaying the icons in the display region A11 is also present. For example, the user can check all the functions by selecting an instruction part P110 of the display region A11. The instruction part P110 is a part serving as a user interface. The instruction part P110 receives an instruction for display of a list screen SC2 explained below. The instruction part P110 may be any part. For example, the instruction part P110 may be a button, an icon, a slide bar, a tab, another image, a figure not classified into an image, text, a sign, or another part.

For example, when the user selects the instruction part P110, as illustrated on the right side of FIG. 2, the user terminal 20 causes the display unit 25 to display a list screen SC2 showing a list of all the functions provided by the application. In the example illustrated on the right side of FIG. 2, not only the icons of the functions displayed in the display region A11 of the instruction screen SC1 but also respective icons of a travel reservation function for the user to use a travel reservation service, a news article function for the user to read news articles, and an advertisement browsing function for the user to browse advertisements are displayed on the list screen SC2. The user can check all the functions by scrolling the list screen SC2.

Note that the list screen SC2 may be a screen displayed to be superimposed on the instruction screen SC1 or may be a screen displayed not to be superimposed on the instruction screen SC1. For example, the list screen SC2 may be a modal, a window, a popup, a banner, or a screen of another form superimposed on the instruction screen SC1. The list screen SC2 may be a screen implemented by Web view or may be a screen of another application different from the application in which the instruction screen SC1 is displayed. When a browser adaptable to a plurality of tabs is used, the list screen SC2 may be a screen displayed on a tab different from the instruction screen SC1.

In the present embodiment, a message is correlated with at least some of the plurality of functions. The message can also be referred to as announcement to the user. The message includes a character string. For example, the message indicates content concerning a function with which the message is correlated. The message is correlated with the function for any purpose. The message is correlated with the function for, for example, notification of a campaign, notification of an event, notification of another schedule, notification of a privilege such as point up, announcement not classified into these kinds of notification, notification of release of a new function, notification of version upgrade, notification of renewal of a function, or another purpose. FIG. 2 is a screen example of the application in the case in which a function with which the message is correlated is absent.

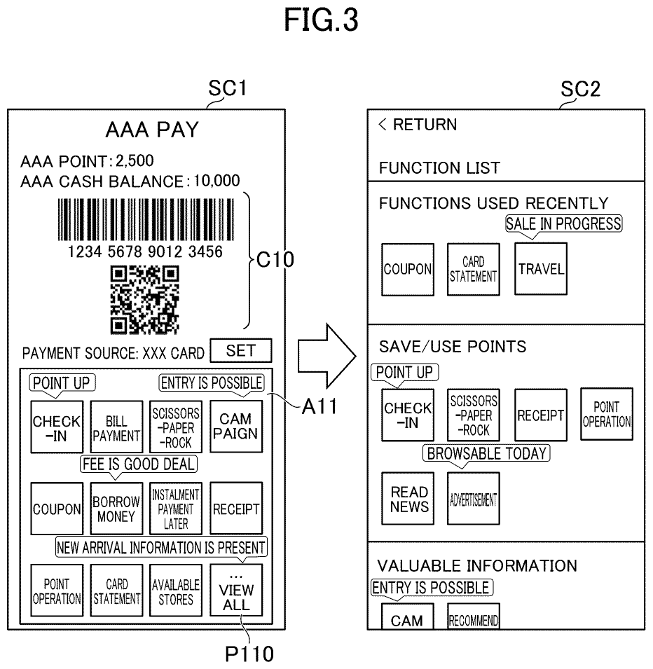

FIG. 3 is a diagram illustrating a screen example of the application in the case in which there is a function with which the message is correlated. In an example illustrated on the left side of FIG. 3, a message “point up” is correlated with the check-in function. A message “entry is possible” is correlated with the campaign function. A message “fee is a good deal” is correlated with the cashing function. When a message is correlated with another function that cannot be displayed in the display region A11, a message “new arrival information is present” is correlated with the instruction part P110. The user can recognize, with the message “new arrival information is present”, that a new arrival message of some function is present on the list screen SC2 ahead of the message.

For example, when the user selects the instruction part P110, as illustrated on the right side of FIG. 3, the user terminal 20 causes the display unit 25 to display the list screen SC2 also including a message not displayed on the instruction screen SC 1. In an example illustrated on the right side of FIG. 3, besides the message that the user can check in the display region A11 of the instruction screen SC1, a message “sale is in progress” correlated with the travel reservation function and a message “browsable today” correlated with the advertisement function are displayed on the list screen SC2. If a message is correlated with a function present at a scroll destination of the list screen SC2, the message is displayed on the list screen SC2.

As explained above, when a function with which a message is correlated is present, the display control system 1 in the present embodiment causes the display unit 25 to display the instruction screen SC1 in which the message “new arrival information is present” is correlated with the instruction part P110. The user can notice, with the message “new arrival information is present” correlated with the instruction part P110, the presence of the message before displaying the list screen SC2. Therefore, the display control system 1 can improve the convenience of the user. Details of the display control system 1 are explained below.

### [3. Functions Implemented by the Display Control System]

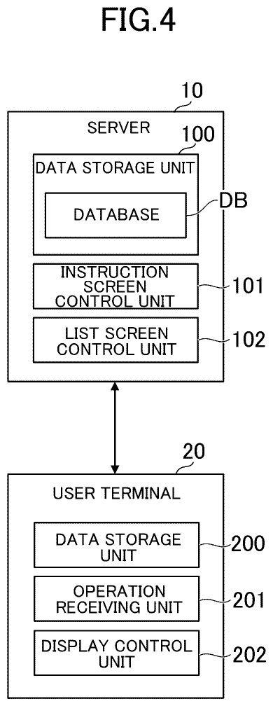

FIG. 4 is a diagram illustrating an example of functions implemented by the display control system 1. In the present embodiment, an example is explained in which main functions concerning screen display of an application are implemented by the server 10. Units implemented by the display control system 1 can be configured by being collected in one device or more finely distributed to devices. For this reason, the functions implemented by the display control system 1 are not limited to the example in the present embodiment.

### [3-1. Functions Implemented by the Server]

For example, the server 10 includes a data storage unit 100, an instruction screen control unit 101, and a list screen control unit 102. The data storage unit 100 is implemented by the storage unit 12. Each of the instruction screen control unit 101 and the list screen control unit 102 is implemented by the control unit 11.

### [Data Storage Unit]

The data storage unit 100 stores data necessary for provision of a predetermined service, an example of which is a settlement service. For example, the data storage unit 100 stores a database DB.

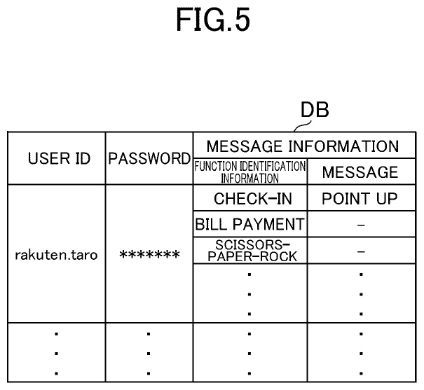

FIG. 5 is a diagram illustrating an example of the database DB. The database DB is a database in which various kinds of information concerning the user are stored. For example, a user ID, a password, and message information are stored in the database DB. Other information may be stored in the database DB. For example, other information such as user attribute information explained in a modification explained below may be stored in the database DB. Information concerning settlement means usable by the user in the settlement service may be stored in the database DB.

The user ID of the settlement service is an example of user identification information capable of identifying the user in the settlement service. A login account may be present separately from the user ID. The user may be able to freely change the login account. The password is information to be checked at the time of login. A code ID is also an ID capable of identifying the user in the settlement service. The code ID is updated every time the code C10 is displayed. The code ID may be stored in the database DB.

The message information is information concerning a message correlated with functions provided in an application. For example, the message information indicates a relation between function identification information capable of identifying each of a plurality of functions and a message correlated with the function. The function identification information is expressed by characters, numbers, signs, or a combination thereof. For example, the function identification information may be a function ID that is an ID allocated to the function or may be a name of the function. The message is specific content of the message. For example, the message is expressed by characters, numbers, signs, images, or a combination thereof. The message information may include information concerning unread/read of the message, date and time when the message was created, a flag indicating whether the message is a new arrival message, or other information.

Note that the message information may be stored in the database DB by any person. For example, a company operating the settlement service inputs content of the message, whereby the message information may be stored in the database DB. Not the company operating the settlement service but a company operating a service of an individual function inputs the content of the message, whereby the message information may be stored in the database DB. At least one of an upper limit number of characters and a lower limit number of characters may be set in the message. The message information may indicate not only specific content of the message but also other information such as design of the message.

In the present embodiment, an example is explained in which message information is stored in the database DB for each user. However, when a common message is displayed for all users, the message information may not be stored in the database DB for each user and common messages may be stored in the data storage unit 100 for all the users. The message information may indicate not specific content of the message but only presence or absence of the message. When a predetermined fixed phrase is used as the message, the message information may be information capable of identifying the fixed phrase. The message information may be stored in another database other than the database DB.

Note that data stored in the data storage unit 100 is not limited to the example explained above. The data storage unit 100 only has to store data necessary for the settlement service. For example, the data storage unit 100 may store data of various screens to be displayed on a settlement application (for example, data of icons of functions or data of a layout of each of the instruction screen SC1 and the list screen SC2). The data storage unit 100 may store data of an API that receives a request from an application stored in the user terminal 20. The data storage unit 100 may store data for notification explained below. For example, the data storage unit 100 may store data of a balloon surrounding a message or may store data indicating a fixed phase message “new arrival information is present”. Display of the instruction screen SC1 and the list screen SC2 may be controlled based on these data. The fixed phrase may be editable by an administrator or the user of the display control system 1. The fixed phrase may be any word and is not limited to the example in the present embodiment.

### [Instruction Screen Control Unit]

The instruction screen control unit 101 causes the user terminal 20, which stores an application for providing a plurality of functions to the user, to display the instruction screen SC1 including the instruction part P110 for the user to instruct display of the list screen SC2 concerning a list of the plurality of functions. In the present embodiment, since the instruction screen control unit 101 is implemented by the server 10, the instruction screen control unit 101 transmits display data of the instruction screen SC1 to the user terminal 20 to thereby cause the user terminal 20 to display the instruction screen SC1.

The application for providing the plurality of functions to the user is an application capable of displaying a part serving as a user interface for the user to select each of the plurality of functions. In the present embodiment, an example is explained in which the icon of each of the functions illustrated in FIGS. 2 and 3 is equivalent to the part. However, the part may be any part. The part is not limited to the icon. For example, the part may be a button, a slide bar, a tab, another image, a figure not classified into an image, text, a sign, or another part. The application includes a program code for displaying the part.

The display data of the instruction screen SC1 is data necessary for display of the instruction screen SC1. The display data of the instruction screen SC1 may be data of the entire instruction screen SC1 or may be data of a part of the instruction screen SC1 (for example, image data indicating an image included in the instruction screen SC1). The display data of the instruction screen SC1 may be any format. For example, the display data of the instruction screen SC1 may be data of a markup language such as HTML or XML, image data, text data, document data, or a combination thereof.

Note that the data storage unit 100 may store the display data itself of the instruction screen SC1 or may store data necessary for generation of the display data of the instruction screen SC1. The instruction screen control unit 101 only has to acquire the display data of the instruction screen SC1 based on any one of these data. The instruction screen control unit 101 may directly transmit the display data of the instruction screen SC1 to the user terminal 20 or may indirectly transmit the display data of the instruction screen SC1 to the user terminal 20 via another computer.

In the present embodiment, when a function with which a message is correlated is present among the plurality of functions, the instruction screen control unit 101 causes the user terminal 20 to display the instruction screen SC1 in which notification concerning the message is correlated with the instruction part P110. In the example illustrated in FIG. 3, the message “new arrival information is present” correlated with the instruction part P110 is equivalent to a message serving as an example of the notification. As explained below, the notification is not limited to the message. For example, the instruction screen control unit 101 determines, based on the message information stored in the database DB, whether a function with which a message is correlated is present. When correlations between messages and functions are defined in another database, the instruction screen control unit 101 may determine, based on the other database, whether a function with which a message is correlated is present. The instruction screen control unit 101 causes, based on a result of determining whether a function with which a message is correlated is present, the user terminal 20 to display the instruction screen SC1.

The function with which the message is correlated is a function, a message relating to which is present. In other words, the function with which the message is correlated is a function that should display the message. For example, in the message information, a function, with function identification information of which a message is correlated, is equivalent to the function with which the message is correlated. In the examples illustrated in FIGS. 2 and 3, a function, near an icon of which (for example, above, below, or on the left, the right, the upper left, the upper right, the lower left, or the lower right of the icon of which) a message is displayed, is equivalent to the function with which the message is correlated.

The notification is an element included in the instruction screen SC1. In the example illustrated on the left side of FIG. 3, the message “new arrival information is present” is equivalent to the notification. The notification is not limited to an image of a balloon illustrated on the left side of FIG. 3. The notification may be another image (for example, an icon) other than the balloon, text (for example, text described in a CSS) indicating a message, notification (for example, a so-called notification dot or notification badge) in which a circular sign or the like is used, notification in a banner format, notification in a popup format, or notification in another format. The notification may be the same content as an entire or a part of message serving as a target of the notification or may be content different from the message serving as the target of the notification. The notification may be a fixed phrase regardless of the message serving as the target of the notification. Note that content of the fixed phrase may change according to the message serving as the target of the notification. The notification may be included in the instruction part P110 of “view all”. A predetermined effect such as shaking may be applied to the notification.

The instruction screen SC1 in which the notification is correlated with the instruction part P110 is the instruction screen SC1 in which the notification is arranged near the instruction part P110 (for example, above, below, or on the left, the right, the upper left, the upper right, the lower left, or the lower right of the icon of the instruction part P110) or on the inside of the instruction part P110. The notification may be a part serving as a user interface or may be an element that does not particularly receive operation of the user. That is, some information processing may be executed when the user selects the notification or nothing may occur even if the user selects the notification. It is assumed that data (for example, image data) necessary for display of the notification is stored in the data storage unit 100. The instruction screen control unit 101 generates the notification based on the data.

When determining that a function with which a message is correlated is absent, the instruction screen control unit 101 causes the user terminal 20 to display the instruction screen SC1 (for example, the instruction screen SC1 on the left side of FIG. 2) in which the notification is not correlated with the instruction part P110. When determining that a function correlated with a message is present, the instruction screen control unit 101 causes the user terminal 20 to display the instruction screen SC1 (for example, the instruction screen SC1 on the left side of FIG. 3) in which the notification is correlated with the instruction part P110.

In the present embodiment, an example is explained in which, if a message is correlated with one function, the instruction screen control unit 101 causes the user terminal 20 to display the instruction screen SC1 in which notification is correlated with the instruction part P110. For this reason, an example is explained in which, even if the function with which the message is correlated is only a function, an icon of which is displayed in the display region A11 of the instruction screen SC1, the instruction screen control unit 101 causes the user terminal 20 to display the instruction screen SC1 in which the notification is correlated with the instruction part P110.

Note that, when the function correlated with the message is only the function, the icon of which is displayed in the display region A11 of the instruction screen SC1, the instruction screen control unit 101 may cause the user terminal 20 to display the instruction screen SC1 in which the notification is not correlated with the instruction part P110. That is, on condition that an icon is not displayed in the display region A11 of the instruction screen SC1 but a message is correlated with a function, an icon of which is displayed on the list screen SC2, the instruction screen control unit 101 may cause the user terminal 20 to display the instruction screen SC1 in which the notification is not correlated with the instruction part P110.

The instruction screen control unit 101 may determine whether a predetermined number (for example, three) or more of functions with which messages are correlated are present. When determining that the predetermined number or more of functions with which messages are correlated are absent, the instruction screen control unit 101 may cause the user terminal 20 to display the instruction screen SC1 in which the notification is not correlated with the instruction part P110. When determining that the predetermined number or more of functions with which messages are correlated are present, the instruction screen control unit 101 may cause the user terminal 20 to display the instruction screen SC1 in which the notification is correlated with the instruction part P110.

The instruction screen SC1 may be a screen displayed to be superimposed on another screen. For example, the instruction screen SC1 may be a modal, a window, a popup, a banner, or a screen of another format superimposed on the other screen. The instruction screen SC1 may be a screen implemented by Web view or may be a screen of another application different from an application in which the list screen SC2 is displayed.

### [List Screen Control Unit]

When the instruction part P110 is selected, the list screen control unit 102 causes the user terminal 20 to display the list screen SC2. For example, a link to the list screen SC2 is included in the instruction part P110. The link is information capable of identifying a screen at a transition destination. For example, the link may be a URL, an ID indicating the screen at the transition destination, or other information. For example, when the instruction part P110 is selected, the user terminal 20 transmits a display request for the list screen SC2 to the server 10 based on the link. The display request is data indicating that display of the list screen SC2 is requested. For example, the display request may be an HTTP request or may be a request in another communication standard. When the server 10 receives the display request for the list screen SC2, the list screen control unit 102 causes the user terminal 20 to display the list screen SC2.

In the present embodiment, since the instruction screen control unit 101 is implemented by the server 10, the instruction screen control unit 101 transmits display data of the list screen SC2 to the user terminal 20 to thereby cause the user terminal 20 to display the list screen SC2. The display data of the list screen SC2 is data necessary for the display of the list screen SC2. The display data of the list screen SC2 may be data of the entire list screen SC2 or may be data of a part of the list screen SC2 (for example, image data indicating an image included in the list screen SC2). The display data of the list screen SC2 may be any format. For example, the display data of the list screen SC2 may be data of a markup language such as HTML or XML, image data, text data, document data, or a combination thereof.

Note that the data storage unit 100 may store the display data itself of the list screen SC2 or may store data necessary for generation of the display data of the list screen SC2. The instruction screen control unit 101 only has to acquire the display data of the list screen SC2 based on any one of these data. The instruction screen control unit 101 may directly transmit the display data of the list screen SC2 to the user terminal 20 or may indirectly transmit the display data of the list screen SC2 to the user terminal 20 via another computer.

In the present embodiment, when a function with which a message to the user is correlated is present among the plurality of functions, the list screen control unit 102 causes the user terminal 20 to display the list screen SC2 in which the message is correlated with the function. For example, the list screen control unit 102 determines, based on the message information stored in the database DB, whether a function with which a message is correlated is present. When correlations between messages and functions are defined in another database, the list screen control unit 102 may determine, based on the other database, whether a function with which a message is correlated is present. The list screen control unit 102 causes, based on a result of the determination about whether a function with which a message is correlated is present, the user terminal 20 to display the list screen SC2.

The list screen SC2 in which the message is correlated with the function is the list screen SC2 in which the message is arranged near an icon of the function (for example, above, below, or on the left, the right, the upper left, the upper right, the lower left, or the lower right of the icon of the function) or on the inside of the icon of the function. The message may be a part serving as a user interface or may be an element that does not particularly receive operation of the user. That is, some information processing may be executed when the user selects the message or nothing may occur even if the user selects the message. It is assumed that data (for example, image data) necessary for the display of the message is stored in the data storage unit 100. The list screen control unit 102 generates the message based on the data.

For example, when determining that a function with which a message is correlated is absent, the instruction screen control unit 101 causes the user terminal 20 to display the list screen SC2 (the list screen SC2 on the right side of FIG. 2) in which a message is not correlated with any function. When determining that a function with which a message is correlated is present, the instruction screen control unit 101 causes the user terminal 20 to display the list screen SC2 (for example, the list screen SC2 on the right side of FIG. 3) in which the message is correlated with the function.

### [3-2. Functions Implemented by the User Terminal]

For example, the user terminal 20 includes a data storage unit 200, an operation receiving unit 201, and a display control unit 202. The data storage unit 200 is implemented by the storage unit 22. The operation receiving unit 201 and the display control unit 202 are implemented by the control unit 21.

### [Data Storage Unit]

The data storage unit 200 stores an application for providing a predetermined service, an example of which is a settlement service, to the user. The application is downloaded beforehand and installed in the user terminal 20. The application may be installed in the user terminal 20 from the beginning. For example, the data storage unit 200 may store various data referred to by the application.

### [Operation Receiving Unit]

The operation receiving unit 201 receives various kinds of operation of the user. For example, the operation receiving unit 201 receives operation on an application. The operation receiving unit 201 transmits data indicating operation content of the user to the server 10.

### [Display Control Unit]

The display control unit 202 causes the display unit 25 to display various screens of an application. For example, the display control unit 202 causes, based on the application, the display unit 25 to display each of the instruction screen SC1 and the list screen SC2. In the present embodiment, an example is explained in which main processing for displaying each of the instruction screen SC1 and the list screen SC2 is executed by the server 10. Therefore, the display control unit 202 causes, based on the application and display data of each of the instruction screen SC1 and the list screen SC2 received from the server 10, the display unit 25 to display each of the instruction screen SC1 and the list screen SC2.

Note that the main processing for displaying each of the instruction screen SC1 and the list screen SC2 may be executed by the user terminal 20. In this case, the server 10 does not include each of the instruction screen SC1 and the list screen SC2 and the display control unit 202 includes the instruction screen control unit 101 and the list screen control unit 102. Each of the instruction screen control unit 101 and the list screen control unit 102 included in the display control unit 202 may communicate with the server 10 according to necessity and cause the display unit 25 to display each of the instruction screen SC1 and the list screen SC2.

### [4. Processing Executed by the Display Control System]

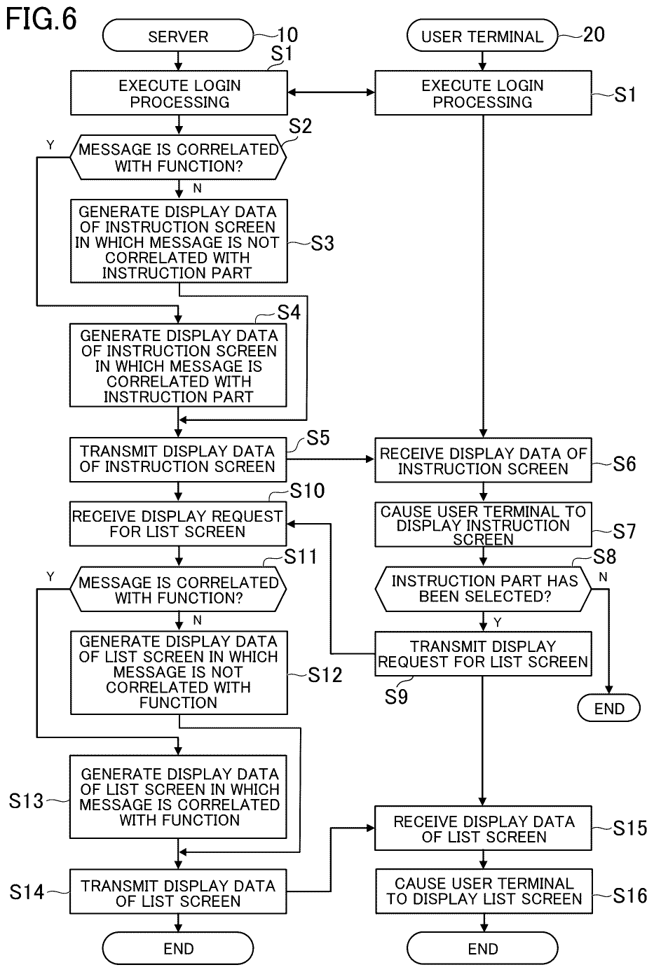

FIG. 6 is a diagram illustrating an example of processing executed by the display control system 1. The control units 11 and 21 respectively execute programs stored in the storage units 12 and 22, whereby the processing illustrated in FIG. 6 is executed.

As illustrated in FIG. 6, when the user operates the operation unit 24 to select an application, the user terminal 20 starts the application stored in the storage unit 22 and executes login processing for the user to log in to a settlement service (S1). When the login processing is successful, the server 10 determines, based on the database DB, whether a message is correlated with each of a plurality of functions (S2). In S2, the server 10 performs determination based on message information correlated with a user ID of the logged-in user.

When determining in S2 that a message is correlated with none of the functions (S2: N), the server 10 generates display data of the instruction screen SC1 in which a message is not correlated with the instruction part P110 (S3). The instruction screen SC1 is the instruction screen SC1 illustrated on the left side of FIG. 2. When determining in S2 that a function with which a message is correlated is present (S2: Y), the server 10 generates display data of the instruction screen SC1 in which the message “new arrival information is present” is correlated with the instruction part P110 (S4). The instruction screen SC1 is the instruction screen SC1 illustrated on the left side of FIG. 3. In S4, if a message is correlated with a function, an icon of which is displayed in the display region A11, the server 10 arranges the message near the icon.

The server 10 transmits the display data of the instruction screen SC1 generated in S3 or S4 to the user terminal 20 (S5). The user terminal 20 receives the display data of the instruction screen SC1 from the server 10 (S6). The user terminal 20 causes the display unit 25 to display the instruction screen SC1 indicated by the display data (S7). In S7, when receiving the display data of the instruction screen SC1 generated in S3, the user terminal 20 causes the display unit 25 to display the instruction screen SC1 illustrated on the left side of FIG. 2. When receiving the display data of the instruction screen SC1 generated in S4, the user terminal 20 causes the display unit 25 to display the instruction screen SC1 illustrated on the left side of FIG. 3.

The user terminal 20 determines, based on a detection signal of the operation unit 24, whether the instruction part P110 has been selected (S8). When it is not determined that the instruction part P110 has been selected (S8: N), this processing ends. When it is determined that the instruction part P110 has been selected (S8: Y), the user terminal 20 transmits a display request for the list screen SC2 to the server 10 (S9). When receiving the display request from the user terminal 20 (S10), the server 10 determines, based on the database DB, whether a message is correlated with each of the plurality of functions (S11). The determination in S11 may be the same as the determination in S2.

When determining in S11 that a message is correlated with none of the functions (S11: N), the server 10 generates display data of the list screen SC2 in which a message is correlated with none of the functions (S12). When determining that a function with which a message is correlated is present (S11: Y), the server 10 generates display data of the list screen SC2 in which the message is correlated with the function (S13). In S13, the server 10 arranges, near an icon of a function indicated by function identification information, a message of content indicated by the message information stored in the database DB and generates display data of the list screen SC2.

The server 10 transmits the display data of the list screen SC2 generated in S12 or S13 to the user terminal 20 (S14). The user terminal 20 receives the display data of the list screen SC2 from the server 10 (S15). The user terminal 20 causes the display unit 25 to display the list screen SC2 (S16) and this processing ends. In S16, when receiving the display data of the list screen SC2 generated in S12, the user terminal 20 causes the display unit 25 to display the list screen SC2 illustrated on the right side of FIG. 2. When receiving the display data of the list screen SC2 generated in S13, the user terminal 20 causes the display unit 25 to display the list screen SC2 illustrated on the right side of FIG. 3.

### [5. Summary of the Embodiment]

When a function with which a message to the user is correlated is present among a plurality of functions, the display control system 1 in the present embodiment causes the user terminal 20 to display the list screen SC2 in which the message is correlated with the function. When a function with which a message is correlated is present among the plurality of functions, the display control system 1 causes the user terminal 20 to display the instruction screen SC1 in which notification concerning the message is correlated with the instruction part P110. Accordingly, the user can notice the presence of the message with notification correlated with the instruction part P110 (in the example on the left side of FIG. 3, the message “new arrival information is present”) even if the display screen SC2 is not displayed. Therefore, the display control system 1 can improve the convenience of the user. The display control system 1 can motivate the user to use the function with which the message is correlated. The display control system 1 can promote use of the function with which the message is correlated. For example, as the number of icons of the functions increases, the number of messages also increases. Therefore, check work of the user is considered to be complicated. However, the display control system 1 can reduce labor and time of the check work of the user with notification correlated with the instruction part P110.

### [6. Modifications]

The present disclosure is not limited to the embodiment explained above. The present disclosure can be changed as appropriate in a range not departing from the gist of the present disclosure.

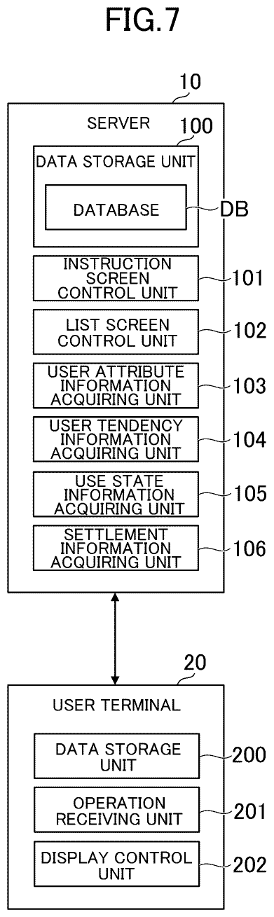

FIG. 7 is a diagram illustrating an example of functions implemented in modifications. For example, the server 10 further includes a user attribute information acquiring unit 103, a user tendency information acquiring unit 104, a use state information acquiring unit 105, and a settlement information acquiring unit 106. Each of the user attribute information acquiring unit 103, the user tendency information acquiring unit 104, the use state information acquiring unit 105, and the settlement information acquiring unit 106 is implemented by the control unit 11.

### [6-1. Modification 1]

For example, in the embodiment, the example is explained in which the fixed phrase message “new arrival information is present” is correlated with the instruction part P110 as the notification. However, notification correlated with the instruction part P110 is not limited to the example in the embodiment. The instruction screen control unit 101 may cause the user terminal 20 to display the instruction screen SC1 in which a message correlated with a certain function is correlated with the instruction part P110 as notification. That is, the instruction screen control unit 101 may cause the user terminal 20 to display the instruction screen SC1 in which the same message as the message correlated with the certain function is correlated with the instruction part P110 as notification.

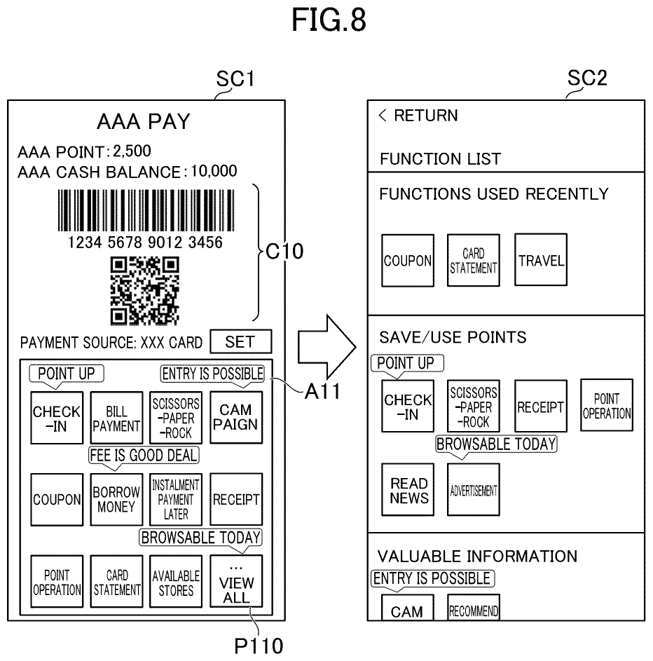

FIG. 8 is a diagram illustrating a screen example of an application in a modification 1. For example, it is assumed that a message “browsable today” is correlated with an advertisement function that is not displayed in the display region A11 of the instruction screen SC1 but is displayed on the list screen SC2. In this case, the instruction screen control unit 101 causes, based on message information indicating the message “browsable today” correlated with the advertisement function, the user terminal 20 to display the instruction screen SC1 in which the same message “browsable today” is correlated with the part P110. The instruction screen control unit 101 is different from that in the embodiment in that the instruction screen control unit 101 correlates not the fixed phrase message “new arrival information is present” but the same message as the message correlated with the certain function with the instruction part P110. Otherwise, the instruction screen control unit 101 is the same as that in the embodiment.

Note that the instruction screen control unit 101 may cause the user terminal 20 to display the instruction screen SC1 in which a message correlated with another function other than the advertisement function is correlated with the instruction part P110. The instruction screen control unit 101 may cause the user terminal 20 to display the instruction screen SC1 in which a message of a function displayed in the display region A11 of the instruction screen SC1 is correlated with the instruction part P110. When a plurality of functions correlated with messages are present, a function may be selected based on a predetermined condition as in a modification 2 explained below. In this case, the instruction screen control unit 101 may correlate a message correlated with a function selected at random with the instruction part P110.

For example, when a message is correlated with only one function among functions displayed on the list screen SC2, as illustrated on the left side of FIG. 8, the instruction screen control unit 101 may cause the user terminal 20 to display the instruction screen SC1 in which the message is correlated with the instruction part P110 as notification. Further, when a plurality of functions with which messages are correlated are present among the functions displayed in the list screen SC2, as illustrated on the left side of FIG. 3, the instruction screen control unit 101 may cause the user terminal 20 to display the instruction screen SC1 in which the fixed phrase message “new arrival information is present” is correlated with the instruction part P110 as notification. In this way, the instruction screen control unit 101 may properly use content of notification according to the number of functions with which messages are correlated. Note that, the instruction screen control unit 101 may properly use the content of the notification as explained above according to the number of functions with which messages are correlated among functions not displayed in the display region A11 of the instruction screen SC1 but displayed on the list screen SC2.

The display control system 1 in the modification 1 causes the user terminal 20 to display the instruction screen SC1 in which a message correlated with a certain function is correlated with the instruction part P110 as notification. Accordingly, the user can learn specific content with the message correlated with the instruction part P110. Therefore, the display control system 1 can further improve the convenience of the user. For example, when a message in which the user is interested is correlated with the instruction part P110, the display control system 1 can motivate the user to select the instruction part P110. The display control system 1 can motivate the user to use a function with which the message is correlated.

### [6-2. Modification 2]

For example, in the modification 1, a plurality of functions with which messages are correlated are sometimes present. When a plurality of functions with which messages are correlated are present, the list screen control unit 102 in a modification 2 causes the user terminal 20 to display the list screen SC2 in which the message of each of the plurality of functions is correlated with the function. When only some of the messages can be correlated with the instruction part P110, a function correlated with the instruction part P110 may be selected based on a predetermined condition.

When a plurality of functions with which messages are correlated are present, the instruction screen control unit 101 in the modification 2 specifies a function satisfying a predetermined condition among the plurality of functions and causes the user terminal 20 to display the instruction screen SC1 in which a message of the function satisfying the predetermined condition is correlated with the instruction part P110. The predetermined condition is a condition for selecting a function of correlating a message with the instruction part P110 among the plurality of functions with which the messages are correlated. In the modification 2, since one message is correlated with the instruction part P110, the predetermined condition is a condition for selecting one function.

Note that, when a plurality of messages correlated with the instruction part P110 are present, the predetermined condition is a condition for selecting the plurality of functions. An upper limit number of two or more may be determined as the number of messages correlated with the instruction part P110. For example, when the number of functions with which messages are correlated is larger than the upper limit number, the instruction screen control unit 101 may narrow down, based on a predetermined condition, messages to be correlated with the instruction part P110 such that the number of functions is fit within a range of the upper limit number.

It is assumed that condition data indicating the predetermined condition is stored in the data storage unit 100. The condition data may be any format. For example, the condition data may be a table format, a numerical expression format, a part of a program, a model of machine learning, or another format. In the modification 2, an example is explained in which an icon being arranged at the top or on the leftmost side on the list screen SC2 is equivalent to the predetermined condition. The instruction screen control unit 101 specifies, based on data indicating a layout of the list screen SC2 (for example, data indicating arrangement of the icon on the list screen SC2; stored in the data storage unit 100), as a function satisfying the predetermined condition, a function present at a predetermined arrangement position of the list screen SC2 (for example, a function present at the top or on the leftmost side of the list screen SC2) among a plurality of functions with which messages are correlated.

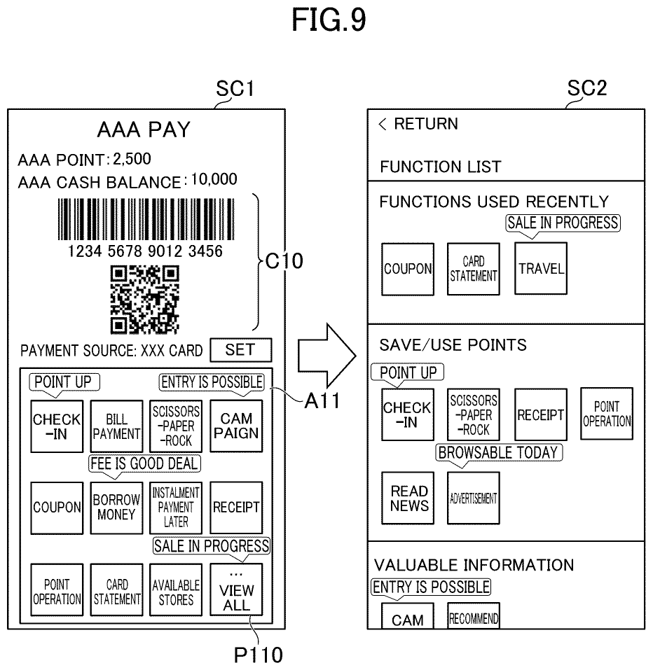

FIG. 9 is a diagram illustrating a screen example of an application in the modification 2. In the example illustrated in FIG. 9, a message is correlated with each of a travel reservation function, a check-in function, an advertisement function, and a campaign function on the list screen SC2. An icon of a function with which a message is correlated is likely to be present at a scroll destination of the list screen SC2. Among these functions, a function, an icon of which is arranged at the top, is the travel reservation function. For this purpose, the instruction screen control unit 101 specifies, among the functions with which the messages are correlated, as the function satisfying the predetermined condition, the travel reservation function present at the top.

For example, the instruction screen control unit 101 causes, based on the message information stored in the database DB, the user terminal 20 to display the instruction screen SC1 in which a message “sale is in progress” of the travel reservation function present at the top is correlated with the instruction part P110. In the modification 2, an example is explained in which the instruction screen control unit 101 narrows down, among functions, icons of which are not displayed in the display region A11, based on a predetermined condition, functions of correlating messages with the instruction part P110. However, the instruction screen control unit 101 may narrow down, regardless of presence or absence of icons in the display region A11, among all the functions, functions of correlating messages with the instruction part P110.

Note that the predetermined condition is not limited to the example in the modification 2. The predetermined condition may be another condition other than the arrangement of the icon on the list screen SC2. For example, the predetermined condition may be conditions explained in modifications 3 to 6 explained below or may be a condition of being a function registered in a favorite explained in a modification 13 explained below. Besides, for example, the predetermined condition may be a condition of being the latest message, a condition of being at a relatively high level among priority levels of functions designated by the administrator of the display control system 1, a condition of being a message including a predetermined keyword, a condition of being a function provided by a sponsor having a relatively high advertisement rate, or another condition.

When a plurality of functions with which messages are correlated are present, the display control system 1 in the modification 2 causes the user terminal 20 to display the list screen SC2 in which the message of each of the plurality of functions is correlated with the function. When a plurality of functions with which messages are correlated are present, the display control system 1 specifies a function satisfying a predetermined condition among the plurality of functions and causes the user terminal 20 to display the instruction screen SC1 in which the message of the function satisfying the predetermined condition is correlated with the instruction part P110. Accordingly, even if a plurality of functions with which messages are correlated are present, the display control system 1 can cause the user terminal 20 to display the instruction screen SC1 in which an appropriate message is correlated with the instruction part P110.

### [6-3. Modification 3]

For example, in the modification 2, the predetermined condition may be condition corresponding to user attribute information concerning an attribute of the user. The attribute of the user is information capable of classifying the user from some viewpoint. For example, the attribute of the user may be sex, age, an age group, a place of residence, an occupation, a family structure, a hobby, an annual income, or other information. In a modification 3, it is assumed that the user attribute information is stored in the database DB in correlation with a user ID. For example, the user attribute information may be information called demographic information. In the modification 3, an example is explained in which the user registers user attribute information of the user in the database DB. However, the server 10 may analyze an action of the user from some viewpoint and store user attribute information corresponding to a result of the analysis in the database DB.

The display control system 1 in the modification 3 includes the user attribute information acquiring unit 103. The user attribute information acquiring unit 103 acquires user attribute information. For example, the user attribute information acquiring unit 103 acquires, from the database DB, user attribute information correlated with a user ID of a logging-in user. When user attribute information is stored in another database other than the database DB, the user attribute information acquiring unit 103 may acquire the user attribute information from the other database. When user attribute information is stored in another computer other than the server 10 or an external information storage medium, the user attribute information acquiring unit 103 may acquire the user attribute information from the other computer or the external information storage medium.

The instruction screen control unit 101 in the modification 3 specifies a function corresponding to user attribute information as a function satisfying a predetermined condition and causes the user terminal 20 to display the instruction screen SC1 in which a message of a function corresponding to the user attribute information is correlated with the instruction part P110. It is assumed that attribute relation data indicating a relation between the user attribute information and at least one of a plurality of functions is stored in the data storage unit 100. The attribute relation data may be any format. For example, the attribute relation data may be a table format, a numerical expression format, a part of a program, a model of machine learning, or another format.

For example, a certain specific attribute and a specific function among a plurality of functions are correlated with the attribute relation data. When the sex of the user is equivalent to an attribute, specific sex and a function in which the user of the sex is estimated to be interested are correlated with the attribute relation data. When an age group of the user is equivalent to the attribute, a certain specific age group and a function in which the user of the age group is estimated as being interested are correlated with the attribute relation data. For the other attributes, similarly, a certain specific attribute and a function in which the user belonging to the attribute is estimated as being interested are correlated with the attribute relation data. A combination of a plurality of attributes and functions in which users of the combination are estimated as being interested may be correlated with the attribute relation data. The administrator of the display control system 1 may designate the relation in the attribute relation data.

For example, the instruction screen control unit 101 specifies, based on the attribute relation data, out of the plurality of attributes, a function correlated with the attribute indicated by the user attribute information as a function corresponding to the user attribute information. If a message is correlated with the function corresponding to the user attribute information, the instruction screen control unit 101 causes the user terminal 20 to display the instruction screen SC1 in which the message is correlated with the instruction part P110. If a message is not correlated with the function corresponding to the user attribute information, the instruction screen control unit 101 may cause the user terminal 20 to display the instruction screen SC1 in which a message correlated with another function is correlated with the instruction part P110 or may cause the user terminal 20 to display the instruction screen SC1 in which no message is particularly correlated with the instruction part P110.

The display control system 1 in the modification 3 specifies a function corresponding to the user attribute information as the function satisfying the predetermined condition and causes the user terminal 20 to display the instruction screen SC1 in which a message of the function corresponding to the user attribute information is correlated with the instruction part P110. Accordingly, the display control system 1 can cause the user to notice, on the instruction screen SC1, a message of an appropriate function corresponding to the user attribute information. Therefore, the display control system 1 can further improve the convenience of the user. For example, when a message in which the user is more interested is correlated with the instruction part P110, the display control system 1 can motivate the user to select the instruction part P110. As a result, the display control system 1 can motivate the user to use a function with which the message is correlated. For example, when the user attribute information indicates a female in thirties, the display control system 1 can perform notification with a higher appeal effect by correlating a message in which the female in thirties is estimated as being interested with the instruction part P110.

### [6-4. Modification 4]

For example, in the modification 2 or the modification 3, the predetermined condition may be a condition corresponding to user tendency information concerning a tendency of the user. The tendency of the user is a tendency corresponding to a use state of a settlement service or a use state of a service provided by an individual function. For example, a user who often settles a small amount in the settlement service is likely to be interested in a point. A user who has used a service provided by the campaign function is likely to be interested in a campaign. A user who has used a service provided by the point operation function is likely to be interested in a point.

Note that the tendency of the user may be a genre of a function in which the user is interested. For example, for a user who tends to make an entry in a campaign, the user tendency information indicates that the user is interested in a campaign. For a user who frequently acquires points, the user tendency information indicates that the user is interested in acquisition of a point. In a modification 4, it is assumed that such user tendency information is stored in the database DB in correlation with a user ID.

For example, the server 10 analyzes a use state of a settlement service or a use state of a service provided by an individual function and stores user tendency information indicating a tendency corresponding to an analysis result in the database DB in correlation with a user ID of the user. It is assumed that relations between use states and tendencies are defined in an analysis program in advance. It is assumed that data indicating use states of the user is stored in the database DB in correlation with the user ID. The server 10 analyzes the use state of the user with the analysis program to thereby specify a tendency of the user. The server 10 stores user tendency information indicating the specified tendency in the database DB in correlation with the user ID of the user.

The display control system 1 in the modification 4 includes the user tendency information acquiring unit 104. The user tendency information acquiring unit 104 acquires user tendency information concerning a tendency of the user estimated from a use state of an estimation service by the user. The estimation service is a service for which a tendency of the user is estimated. The estimation service may be the same as the predetermined service explained above, an example of which is the settlement service, or may be another service different from the predetermined service. The other service may be a service provided by a function usable from the predetermined service.

For example, the user tendency information acquiring unit 104 acquires, from the database DB, user tendency information correlated with a user ID of a logging-in user. When user tendency information is stored in another database other than the database DB, the user tendency information acquiring unit 104 may acquire the user tendency information from the other database. When user tendency information is stored in another computer other than the server 10 or an external information storage medium, the user tendency information acquiring unit 104 may acquire the user tendency information from the other computer or the external information storage medium.

The instruction screen control unit 101 in the modification 4 specifies a function corresponding to the user tendency information as a function satisfying a predetermined condition and causes the user terminal 20 to display the instruction screen SC1 in which a message of the function corresponding to the user tendency information is correlated with the instruction part P110. It is assumed that tendency relation data indicating a relation between the user tendency information and at least one of the plurality of functions is stored in the data storage unit 100. The tendency relation data may be any format. For example, the tendency relation data may be a table format, a numerical expression format, a part of a program, a model of machine learning, or another format.

For example, a certain specific tendency and a specific function among a plurality of functions are correlated with the tendency relation data. When interest in a point is equivalent to the tendency, a tendency indicating the interest in the point and a function concerning the point are correlated with the tendency relation data. When entry in a campaign is equivalent to the tendency, a tendency indicating the entry in the campaign and a function concerning the campaign are correlated with the tendency relation data. For the other tendencies, similarly, a certain specific tendency and a function in which a user belonging to the tendency is estimated as being interested are correlated with the tendency relation data. A combination of a plurality of tendencies and functions in which users having the combination are estimated as being interested are correlated with the tendency relation data. The administrator of the display control system 1 may designate a relation in the tendency relation data.

For example, the instruction screen control unit 101 specifies, based on the tendency relation data, out of a plurality of tendencies, a function correlated with a tendency indicated by the user tendency information as a function corresponding to the user tendency information. If a message is correlated with the function corresponding to the user tendency information, the instruction screen control unit 101 causes the user terminal 20 to display the instruction screen SC1 in which the message is correlated with the instruction part P110. If a message is not correlated with the function corresponding to the user tendency information, the instruction screen control unit 101 may cause the user terminal 20 to display the instruction screen SC1 in which a message correlated with another function is correlated with the instruction part P110 or may cause the user terminal 20 to display the instruction screen SC1 in which no message is particularly correlated with the instruction part P110.

The display control system 1: in the modification 4 specifies a function corresponding to the user tendency information as a function satisfying the predetermined condition and causes the user terminal 20 to display the instruction screen SC1 in which a message of the function corresponding to the user tendency information is correlated with the instruction part P110. Accordingly, the display control system 1 can cause the user to notice, on the instruction screen SC1, a message of an appropriate function corresponding to the user identification information. Therefore, the display control system 1 can further improve the convenience of the user. For example, when a message in which a user having a certain specific tendency is interested is correlated with the instruction part P110, the display control system 1 can motivate the user to select the instruction part P110. As a result, the display control system 1 can motivate the user to use a function with which the message is correlated.

### [6-5. Modification 5]

For example, in any one of the modification 2 to the modification 4, the predetermined condition may be a condition corresponding to use state information concerning a use state of each of the plurality of functions by the user. The use state of the function by the user can also be considered at least one of a selection history and a use history of the function. For example, the use state of the function by the user may be the number of times the user selected the function (for example, the number of times the user selected an icon indicating the function), the number of times the user used the function, a frequency of the user using the function, an elapsed time from when the user stared to use the function, an elapsed time from when the user used the function last, a function used by the user most recently, or another state. In a modification 5, it is assumed that the use state information is stored in the database DB in correlation with a user ID. When receiving data concerning operation on an application from the user terminal 20, the server 10 updates use state information stored in the database DB.

The display control system 1 in the modification 5 includes the use state information acquiring unit 105. The use state information acquiring unit 105 acquires use state information concerning a use state of each of a plurality of functions by the user. For example, the use state information acquiring unit 105 acquires, from the database DB, use state information correlated with a user ID of a logging-in user. When use state information is stored in another database other than the database DB, the use state information acquiring unit 105 may acquire the use state information from the other database. When use state information is stored in another computer other than the server 10 or an external information storage medium, the use state information acquiring unit 105 may acquire the use state information from the other computer or the external information storage medium.

The instruction screen control unit 101 in the modification 5 specifies a function corresponding to the use state information as a function satisfying the predetermined condition and causes the user terminal 20 to display the instruction screen SC1 in which a message of the function corresponding to the use state information is correlated with the instruction part P110. It is assumed that use state relation data indicating a relation between the use state information and at least one of the plurality of functions is stored in the data storage unit 100. The use state relation data may be any format. For example, the use state relation data may be a table format, a numerical expression format, a part of a program, a model of machine learning, or another format.

For example, a certain specific use state and a specific function among the plurality of functions are correlated with the use state relation data. The use state relation data may indicate that a function having the largest number of times of selection, the largest number of times of use, or the highest use frequency is selected. The use state relation data may indicate that a function having the longest or shortest elapsed time from when the user started to use the function is selected. The use state relation data may indicate that a function used by the user most recently is selected. For other use states, similarly, a method of selecting a function corresponding to the use state may be defined in the use state relation data. The use state relation data may be defined by the administrator of the display control system 1.

For example, the instruction screen control unit 101 specifies, based on the use state relation data, out of a plurality of use states, a function correlated with a use state indicated by the use state information as a function corresponding to the use state information. If a message is correlated with the function corresponding to the use state information, the instruction screen control unit 101 causes the user terminal 20 to display the instruction screen SC1 in which the message is correlated with the instruction part P110. If a message is not correlated with the function corresponding to the use state information, the instruction screen control unit 101 may cause the user terminal 20 to display the instruction screen SC1 in which a message correlated with another function is correlated with the instruction part P110 or may cause the user terminal 20 to display the instruction screen SC1 in which no message is particularly correlated with the instruction part P110.

The display control system 1 in the modification 5 specifies a function corresponding to the use state information as the function satisfying the predetermined condition and causes the user terminal 20 to display the instruction screen SC1 in which a message of the function corresponding to the use state information is correlated with the instruction part P110. Accordingly, the display control system 1 can cause the user to notice, on the instruction screen SC1, a message of an appropriate function corresponding to the use state information. Therefore, the display control system 1 can further improve the convenience of the user. For example, when a message in which a user in a certain specific use state is interested is correlated with the instruction part P110, the display control system 1 can motivate the user to select the instruction part P110. As a result, the display control system 1 can motivate the user to use a function with which the message is correlated.

Note that, as explained above, the use state information may indicate the number of times the user selected the function. For example, for a user who always selects a function, a message of which is displayed on the settlement application, the instruction screen control unit 101 may cause the user terminal 20 to display a fixed phrase in correlation with the instruction part P110. For a user who does not always select the function, the instruction screen control unit 101 may cause the user terminal 20 to display the message itself on the instruction part P110. For example, the use state information may indicate a message selected by the user among messages correlated with each of the plurality of functions. The use state information may indicate the number of times of selection of an individual message. When the message is not a part of a user interface, the use state information may indicate the number of times icons of the functions were selected.

For example, when the user performs operation on an application, the user terminal 20 transmits data indicating operation content of the user to the server 10. The server 10 receives the data from the user terminal 20 and updates the use state information based on the data. For example, when the user has selected a certain message, the server 10 updates the use state information to indicate that the message has been selected. When the use state information indicates the number of times of selection of an individual message or function, the server 10 increments the number of times of selection indicated by the use state information. For example, the instruction screen control unit 101 may cause the user terminal 20 to display the instruction screen SC1 in which notification corresponding to the number of times of section indicated by the use state information is correlated with the instruction part P110.

### [6-6. Modification 6]

For example, in any one of the modification 2 to the modification 5, the predetermined condition may be a condition corresponding to settlement information concerning settlement performed by the user from a settlement application, an example of which is the application explained in the embodiment. As in the embodiment, it is assumed that the application in a modification 6 is a settlement application for the user to use the settlement service. The settlement information can also be referred to as a settlement history. For example, the settlement information may be a settlement place, a settlement amount, a settlement time, a commodity or a service serving as a target of the settlement, presence or absence of point allocation, a type of settlement means used in the settlement, or other information.

In the modification 6, it is assumed that the settlement information is stored in the database DB in correlation with a user ID. For example, when the user executes settlement from the settlement application, the server 10 updates, based on an execution result of the settlement, settlement information stored in the database DB. The settlement information can also be referred to as information indicating a history of settlement by the user. The settlement information may be information used in a publicly-known settlement service.

The display control system 1 in the modification 6 includes the settlement information acquiring unit 106. The settlement information acquiring unit 106 acquires settlement information concerning the settlement performed by the user from the settlement application. For example, the settlement information acquiring unit 106 acquires, from the database DB, settlement information correlated with a user ID of a logging-in user. When settlement information is stored in another database other than the database DB, the settlement information acquiring unit 106 may acquire the settlement information from the other database. When settlement information is stored in another computer other than the server 10 or an external information storage medium, the settlement information acquiring unit 106 may acquire the settlement information from the other computer or the external information storage medium.

The instruction screen control unit 101 in the modification 6 specifies a function corresponding to the settlement information as the function satisfying the predetermined condition and causes the user terminal 20 to display the instruction screen SC1 in which a message of the function corresponding to the settlement information is correlated with the instruction part P110. It is assumed that settlement related data indicating a relation between the settlement information and at least one of the plurality of functions is stored in the data storage unit 100. The settlement related data may be any format. For example, the settlement related data may be a table format, a numerical expression format, a part of a program, a model of machine learning, or another form.

For example, certain specific settlement and a specific function among the plurality of functions are correlated with the settlement related data. A certain specific settlement amount (for example, a settlement amount equal to or larger than a threshold) and a certain specific function (for example, an instalment payment function) may be correlated with the settlement related data. Certain specific settlement means (for example, a credit card) and a certain specific function (for example, a cashing function) may be correlated with the settlement related data. A relation between other conditions concerning settlement and a function, presence of a message of which should be notified to the user, may be defined in the settlement related data. The settlement related data may be defined by the administrator of the display control system 1.

For example, the instruction screen control unit 101 specifies, based on the settlement related data, out of a plurality of settlements, a function correlated with the settlement indicated by the settlement information as a function corresponding to the settlement information. If a message is correlated with the function corresponding to the settlement information, the instruction screen control unit 101 causes the user terminal 20 to display the instruction screen SC1 in which the message is correlated with the instruction part P110. If a message is not correlated with the function corresponding to the settlement information, the instruction screen control unit 101 may cause the user terminal 20 to display the instruction screen SC1 in which a message correlated with another function is correlated with the instruction part P110 or may cause the user terminal 20 to display the instruction screen SC1 in which no message is particularly correlated with the instruction part P110.

The display control system 1 in the modification 6 specifies a function corresponding to the settlement information as the function satisfying the predetermined condition and causes the user terminal 20 to display the instruction screen SC1 in which a message of the function corresponding to the settlement information is correlated with the instruction part P110. Accordingly, the display control system 1 can cause the user to notice, on the instruction screen SC1, a message of an appropriate function corresponding to the settlement information. Therefore, the display control system 1 can further improve the convenience of the user. For example, when a message in which a user who has performed certain specific settlement is interested is correlated with the instruction part P110, the display control system 1 can motivate the user to select the instruction part P110. As a result, the display control system 1 can motivate the user to use a function with which the message is correlated. For example, when the user has executed, with an application, settlement with a credit card set as a payment source, by correlating, with the instruction part P110, a message “check a payment amount” correlated with the card statement function, the display control system 1 can urge the user to use a function for checking a payment amount.

### [6-7. Modification 7]

For example, in the embodiment, a case is explained in which information (for example, a name, a part of the name, or an icon) that can identify a specific function like the message “new arrival information is present” on the instruction screen SC1 on the left side of FIG. 3 is not correlated with the instruction part P110. In a modification 7, an example is explained in which the instruction screen control unit 101 causes the user terminal 20 to display the instruction screen SC1 in which a name of a function with which a message is correlated with the instruction part P110 as notification.

Note that it is assumed that the information that can identify the function is indicated by the function identification information included in the message information stored in the database DB. The information that can identify the function may be stored in another place other than the database DB. In the modification 7, the instruction screen control unit 101 specifies information concerning various functions based on the function identification information. The instruction screen control unit 101 specifies, based on the message information stored in the database DB, with which function a message is correlated and generates notification including information concerning the function and correlates the notification with the instruction part P110.

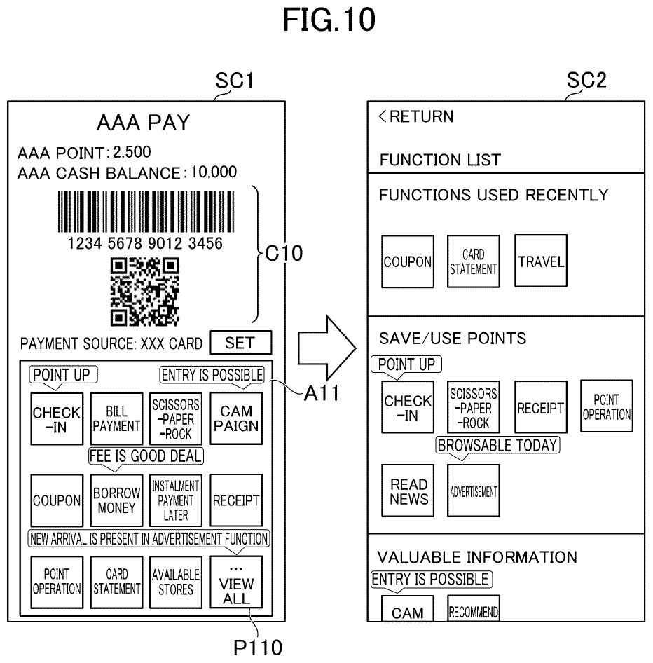

FIG. 10 is a diagram illustrating a screen example of an application in the modification 7. As illustrated on the left side of FIG. 10, the instruction screen control unit 101 causes the user terminal 20 to display the instruction screen SC1 in which a message “new arrival is present in the advertisement function” indicating information “advertisement function” of a function with which a message is correlated is correlated with the instruction part P110 as notification. In the message “new arrival is present in the advertisement function”, a portion of a character string “advertisement function” is the information of the function. A portion of a character string “new arrival is present in” is a fixed phrase. The message correlated with the instruction part P110 as the notification may indicate only the information of the function. For example, when the user selects the instruction part P110, as illustrated on the right side of FIG. 10, the list screen control unit 102 causes the user terminal 20 to display the list screen SC2 in which a message is correlated with a function, information of which is correlated with the instruction part P110. A method of displaying the list screen SC2 may be the same as the method in the embodiment.

The display control system 1 in the modification 7 causes the user terminal 20 to display the instruction screen SC1 in which information of a function with which a message is correlated is correlated with the instruction part P110. Accordingly, the user can easily grasp, from the notification correlated with the instruction part P110, with which function a message is correlated. Therefore, the display control system 1 can improve the convenience of the user. For example, when information of a function in which the user is interested is correlated with the instruction part P110 as notification, the user can easily notice, from the instruction screen SC1, that a message is correlated with the function in which the user is interested. The display control system 1 can motivate the user to use the function with which the message is correlated.

Note that, in the modification 7, the instruction screen control unit 101 may cause the user terminal 20 to display the instruction screen SC1 in which information of a function with which a message is correlated and at least a part of the message are correlated with the instruction part P110 as notification. An example is explained in which notification correlated with the instruction part P110 indicates the information of the function and the entire message. However, the notification correlated with the instruction part P110 may indicate the information of the function and content of only a part of the message. That is, in the notification correlated with the instruction part P110, content of a part of the message may be omitted.

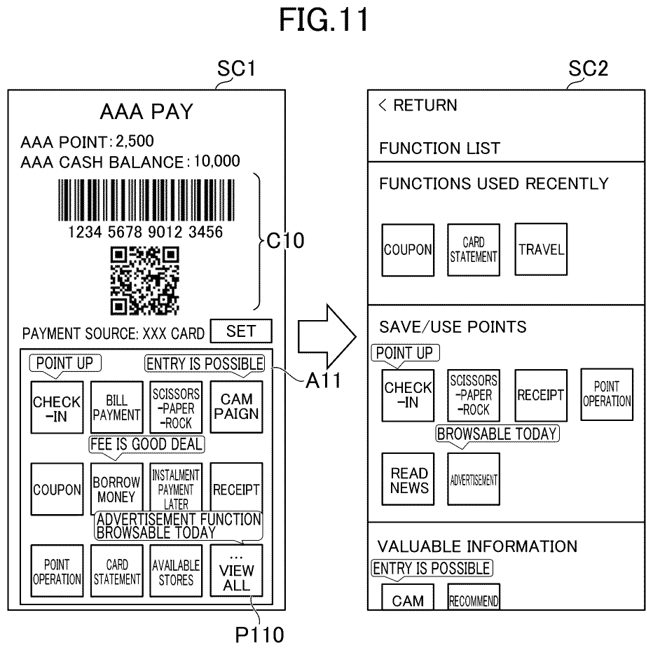

FIG. 11 is a diagram illustrating a screen example of an application in the modification 7. As illustrated on the left side of FIG. 11, the instruction screen control unit 101 causes the user terminal 20 to display the instruction screen SC1 in which notification indicating information “advertisement function” of a function with which a message is correlated and the entire message “browsable today” is correlated with the instruction part P110. The instruction screen control unit 101 only has to acquire information of a function with which a message is correlated as in the modification 7. The instruction screen control unit 101 only has to acquire a message that should be correlated with the instruction part P110 as notification as in any one of the modifications 1 to 6. The instruction screen control unit 101 causes the user terminal 20 to display the instruction screen SC1 in which notification indicating the acquired information and at least a part of the acquired message is correlated with the instruction part P110.

Note that the instruction screen control unit 101 may cause the user terminal 20 to display the instruction screen SC1 in which notification indicating information “advertisement function” of a function with which a message is correlated and a part “today” of the message “browsable today” is correlated with the instruction part P110. For example, when the number of characters included in the notification is limited, the instruction screen control unit 101 may correlate a part of a message with the instruction part P110 as notification within a range of the number of characters.

The display control system 1 in the modification 7 causes the user terminal 20 to display the instruction screen SC1 in which information of a function with which a message is correlated and at least a part of the message are correlated with the instruction part P110 as notification. Accordingly, the user can easily grasp, from the notification correlated with the instruction part P110, not only with which function a message is correlated but also content of the message. Therefore, the display control system 1 can improve the convenience of the user. For example, when a message of content in which the user is interested is correlated with the instruction part P110 as notification, the user can easily notice, from the instruction screen SC1, that a message is correlated with a function in which the user is interested. The display control system 1 can motivate the user to use the function with which the message is correlated.

### [6-8. Modification 8]

For example, in the modifications 2 to 6, a case is explained in which any one of the plurality of messages is selected and correlated with the instruction part P110. However, notification of each of the plurality of messages may be correlated with the instruction part P110. When a plurality of messages are present, the instruction screen control unit 101 in a modification 8 causes the user terminal 20 to display the instruction screen SC1 in which notification of each of the plurality of messages is correlated with the instruction part P110.

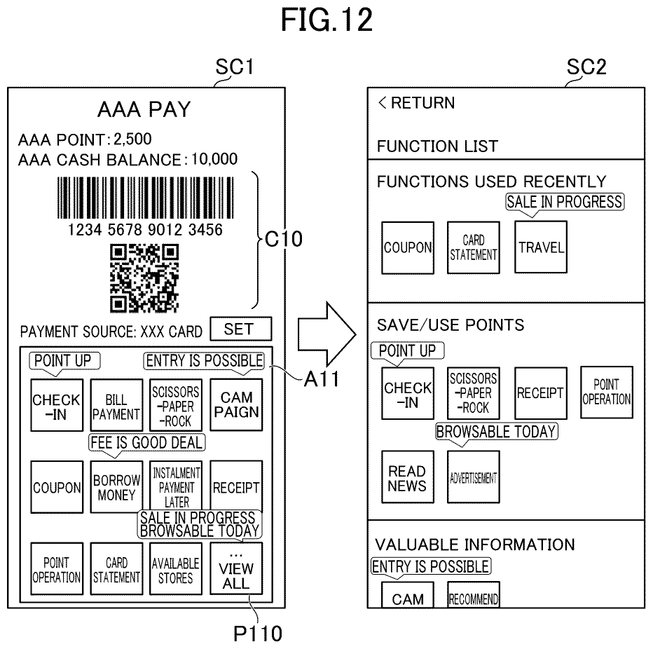

FIG. 12 is a diagram illustrating a screen example of an application in the modification 8. As illustrated on the left side of FIG. 12, the instruction screen control unit 101 causes the user terminal 20 to display the instruction screen SC1 in which each of the message “sale is in progress” correlated with the travel reservation function and the message “browsable today” correlated with the advertisement function is correlated with the instruction part P110 as notification of these functions. When specifying, based on the message information stored in the database DB, that messages are correlated with a plurality of functions, the instruction screen control unit 101 correlates notification of each of the plurality of functions with the instruction part P110. A method itself of correlating an individual notification with the instruction part P110 may be the same as the method in the embodiment.

Note that, in an example on the left side of FIG. 12, two kinds of notification are correlated with the instruction part P110. However, the number of kinds of notification correlated with the instruction part P110 is not limited to two. For example, three or more kinds of notification may be correlated with the instruction part P110. When an upper limit is provided for the number of kinds of notification correlated with the instruction part P110, the instruction screen control unit 101 may correlate notification of each of a plurality of messages with the instruction part P110 within a range of the upper limit. A method of selecting a message correlated as notification out of all the messages may be the same as the method in the modifications 2 to 6.

When the user selects the message “new arrival information is present” in a state in which the instruction screen SC1 in which the message “new arrival information is present” is correlated with the instruction part P110 as illustrated on the left side of FIG. 3, the instruction screen control unit 101 may cause the user terminal 20 to display the instruction screen SC1 in which the message “sale is in progress” and the message “browsable today” are correlated with the instruction part P110. That is, the user may be able to check a plurality of messages on the instruction screen SC1 without transitioning to the list screen SC2. When the modification 7 and the modification 8 are combined, the instruction screen control unit 101 may cause the user terminal 20 to display the instruction screen SC1 in which information of each of a plurality of functions with which messages are correlated and the messages are correlated with the instruction part P110.

When a plurality of messages are present, the display control system 1 in the modification 8 causes the user terminal 20 to display the instruction screen SC1 in which notification of each of the plurality of messages is correlated with the instruction part P110. Accordingly, the user can notice presence of a larger number of messages on the instruction screen SC1. Therefore, the display control system 1 can further improve the convenience of the user. By notifying presence of a larger number of messages in correlation with the instruction part P110, the display control system 1 can motivate the user to use functions with which the messages are correlated.

### [6-9. Modification 9]

For example, as explained in the embodiment, when the user selects the instruction part P110 with which notification is correlated, the list screen control unit 102 causes the user terminal 20 to display the list screen SC2 that is a list of functions correlated with messages indicated by the notification. Various messages are sometimes displayed on the list screen SC2. Therefore, it is difficult for the user to find, from the list screen SC2, which message is indicated by notification correlated with the instruction part P110. Thus, in a modification 9, an example is explained in which the list screen SC2 on which the user can easily find the message is displayed.

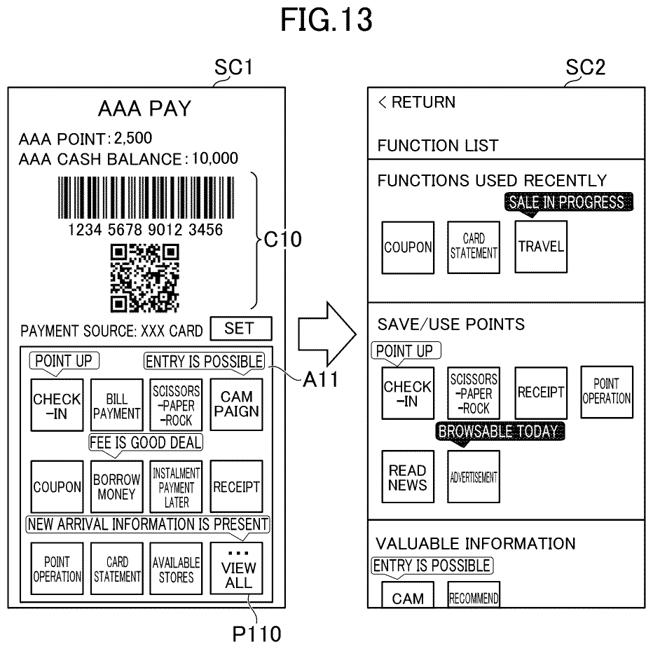

FIG. 13 is a diagram illustrating a screen example of an application in the modification 9. When the instruction part P110 is selected, the list screen control unit 102 in the modification 9 causes the user terminal 20 to display the list screen SC2 in which a function notified by the instruction screen SC1 is highlighted. The highlighting of the function means distinguishing an appearance from an appearance of the other functions on the list screen SC2. For example, the highlighting of the function means differentiating an appearance (for example, a size, a color, a shape, or a pattern) of a message, differentiating an appearance (for example, a size, a color, a shape, or a pattern) of an icon of the function, setting display order relatively earlier (for example, the upper side of the left side), a screen effect being applied, or a combination thereof.

For example, the list screen control unit 102 causes the user terminal 20 to display the list screen SC2 in which a function, notification of which is correlated with the instruction part P110, and a function, notification of which is not correlated with the instruction part P110, are distinguished. In the example illustrated on the left side of FIG. 13, the instruction screen SC1 in the case in which a message is present for each of the travel reservation function and the advertisement function is illustrated. The instruction screen SC1 may be the same as the instruction screen SC1 illustrated on the left side of FIG. 3. When the user selects the instruction part P110, as illustrated on the right side of FIG. 13, the list screen control unit 102 causes the user terminal 20 to display the list screen SC2 in which an appearance (in the example illustrated in FIG. 13, a color schematically represented by halftone dots) of a message of each of the travel reservation function and the advertisement function is differentiated from an appearance of messages of the other functions. The list screen control unit 102 may cause the user terminal 20 to highlight the advertisement function with another element such as an appearance of an icon of the advertisement function.

When the instruction part P110 has been selected, the display control system 1 in the modification 9 causes the user terminal 20 to display the list screen SC2 in which a function notified by the instruction screen SC1 is highlighted. Accordingly, the user can easily find, from the list screen SC2, which message is indicated by notification correlated with the instruction part P110. Therefore, the display control system 1 can further improve the convenience of the user.

### [6-10. Modification 10]

For example, in the modification 8, the example is explained in which each of the plurality of messages is correlated with the instruction part P110 as the notification. Depending on the instruction screen SC1, not so many kinds of notification sometimes can be displayed. Thus, when a plurality of messages are present, the instruction screen control unit 101 in a modification 10 causes the user terminal 20 to display the instruction screen SC1 in which notification concerning the number of the plurality of messages is correlated with the instruction part P110. The instruction screen control unit 101 may acquire the number of messages correlated with other functions other than a function, an icon of which is displayed in the display region A11 of the instruction screen SC1, and correlate the number of messages with the instruction part P110 or may acquire the number of messages among all the functions regardless of whether icons are displayed in the display region A11 and correlate the number of messages with the instruction part P110.

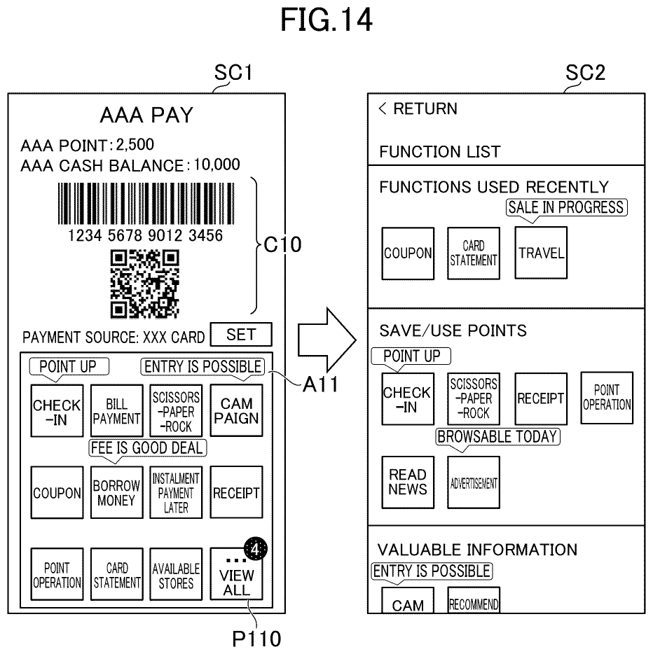

FIG. 14 is a diagram illustrating a screen example of an application in the modification 10. For example, as illustrated on the left side of FIG. 14, the instruction screen control unit 101 acquires the number of messages based on message information of the database DB and causes the user terminal 20 to display the instruction screen SC1 in which badge notification indicating the number is correlated with the instruction part P110. The number of messages may be the number of new arrival messages or may be the number of messages not read by the user. In an example illustrated on the left side of FIG. 14, the badge notification is a circular figure including a numerical value “4” displayed on the upper right of the instruction part P110. The badge notification may be publicly-known design.

Note that the instruction screen control unit 101 may perform notification concerning the number of messages with a method other than the badge notification. For example, the instruction screen control unit 101 may cause the user terminal 20 to display the instruction screen SC1 in which notification such as a message “four new arrivals” is correlated with the instruction part P110. The instruction screen control unit 101 may cause the user terminal 20 to display the instruction screen SC1 including the instruction part P110 indicating the number of messages. That is, the number of messages may be included in the instruction part P110. For example, when the user selects the instruction part P110, as illustrated on the right side of FIG. 14, the list screen control unit 102 causes the user terminal 20 to display the list screen SC2 including at least a message of the number indicated by the notification correlated with the instruction part P110. A method of displaying the list screen SC2 may be the same as the method in the embodiment.

When a plurality of messages are present, the display control system 1 in the modification 10 causes the user terminal 20 to display the instruction screen SC1 in which notification concerning the number of the plurality of messages is correlated with the instruction part P110. Accordingly, the user can easily grasp the number of messages from the notification correlated with the instruction part P110. Therefore, the display control system 1 can improve the convenience of the user.

### [6-11. Modification 11]

For example, in the embodiment, as in the instruction screen SC1 illustrated in FIG. 2 and FIG. 3, the icon for the user to select some of the plurality of functions is displayed in the display region A11. Such an icon functions as a part of a user interface. In a modification 11, the icon displayed in the display region A11 (an icon other than the instruction part P110) is referred to as selection part. The instruction screen control unit 101 in the modification 11 causes the user terminal 20 to display the instruction screen SC1 further including a selection part for the user to select some of a plurality of functions. The selection part is not limited to the icon in the display region A11 in FIG. 2 and FIG. 3 and may be another part illustrated in the embodiment.

For example, when a message is correlated with some of a plurality of functions, the instruction screen control unit 101 causes the user terminal 20 to display the instruction screen SC1 in which the message is correlated with the selection part. The modification 11 is different from the embodiment in that the selection part is not limited to an icon. However, processing for correlating the message with the selection part may be as explained in the embodiment. The instruction screen control unit 101 only has to determine, based on the message information stored in the database DB, whether messages are correlated with functions indicated by selection parts and cause the user terminal 20 to display the instruction screen SC1 in which a message is correlated with a selection part of a function with which the message is correlated.

The display control system 1 in the modification 11 causes the user terminal 20 to display the instruction screen SC1 further including a selection part for the user to select some of a plurality of functions. When a message is correlated with the some functions, the display control system 1 causes the user terminal 20 to display the instruction screen SC1 in which the message is correlated with the selection part. Accordingly, the user can check, from the instruction screen SC1, the message correlated with certain some functions. Therefore, the display control system 1 can further improve the convenience of the user.

### [6-12. Modification 12]

For example, as explained a little in the embodiment and the modification 11, when a message is correlated with another function (for example, a function, an icon of which is not displayed unless transitioning to the list screen SC2) other than the some functions (for example, a function, an icon of which is displayed in the display region A11) explained in the modification 11, the instruction screen control unit 101 may cause the user terminal 20 to display the instruction screen SC1 in which notification of the other function is correlated with the instruction part P110.

For example, even if a message is correlated with a function, an icon of which is displayed in the display region A11, the instruction screen control unit 101 does not correlate notification of the message with the instruction part P110. When a message is correlated with another function, an icon of which is not displayed in the display region A11 (another function, an icon of which is not displayed unless transitioning to the list screen SC2), the instruction screen control unit 101 causes the user terminal 20 to display the instruction part P110 with which notification for the message is correlated.

For example, the instruction screen control unit 101 may display only the notification of the other function and may not display the notification of the some functions in the instruction part P110. When messages are present for both of the other function and the some functions, the instruction screen control unit 101 may prioritize the notification of the other function and cause the user terminal 20 to display the notification of the other function in the instruction part P110. Further, when a message is absent for the other function, the instruction screen control unit 101 may perform the notification of the some functions.

When a message is correlated with another function other than the some functions explained in the modification 11, the display control system 1 in a modification 12 causes the user terminal 20 to display the instruction screen SC1 in which notification of the other function is correlated with the instruction part P110. Accordingly, the user can check, on the instruction screen SC1, the notification of the message of the other function that cannot be checked on the instruction screen SC1. Therefore, the display control system 1 can improve the convenience of the user.

Note that, in the modification 12, when a message correlated with the some functions (for example, a function, an icon of which is displayed in the display region A11) explained in the modification 11 and a message correlated with another function (for example, a function, an icon of which is not displayed unless transitioning to the list screen SC2) other than the some functions are present, the instruction screen control unit 101 may prioritize notification of the message correlated with the other function over notification of the message correlated with the some functions.

In the modification 12, when a message, an icon of which is not displayed in the display region A11, is absent, the instruction screen control unit 101 causes the user terminal 20 to display the instruction screen SC1 in which notification of a message, an icon of which is displayed in the display region A11, is correlated with the instruction part P110. For example, when a message, an icon of which is not displayed in the display region A11, is present, the instruction screen control unit 101 causes the user terminal 20 to display the instruction screen SC1 in which notification of the message, the icon of which is displayed in the display region A11, is not correlated with the instruction part P110 and notification of a message of another function is correlated with the instruction part P110.

Note that, even if a message, an icon of which is not displayed in the display region A11, is present, the instruction screen control unit 101 may cause the user terminal 20 to display the instruction screen SC1 in which the notification of the message, the icon of which is displayed in the display region A11, is correlated with the instruction part P110. The instruction screen control unit 101 may cause the user terminal 20 to display the instruction screen SC1 in which the notification of the message of the other function is correlated with the instruction part P110 to be earlier in order (for example, on the upper side) than the notification of the message, the icon of which is displayed in the display region A11.

When a message correlated with the some functions explained in the modification 11 and a message correlated with another function other than the some functions are present, the display control system 1 in the modification 12 prioritizes notification of the message correlated with the other function over notification of the message correlated with the some functions. Accordingly, the user can preferentially check, on the instruction screen SC1, the notification of the message of the other function that cannot be checked on the instruction screen SC1. Therefore, the display control system 1 can improve the convenience of the user.

### [6-13. Modification 13]

For example, in the embodiment, the case is explained in which the instruction part P110 is a part for display of the list screen SC2 showing a list of all functions. The list screen control unit 102 may cause the user terminal 20 to display the list screen SC2 concerning a list of some functions selected by the user among all functions provided by an application. That is, the list screen SC2 may show not a list of all the functions but a list of some functions selected by the user among all the functions. In a modification 13, the instruction part P110 explained in the embodiment is referred to as first instruction part P110A. Further, the list screen SC2 explained in the embodiment is referred to as first list screen SC2A.

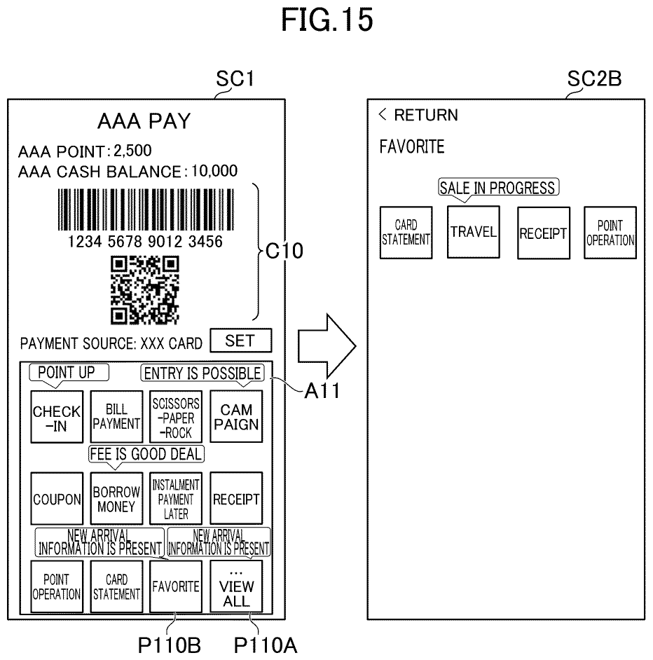

FIG. 15 is a diagram illustrating a screen example of an application in the modification 13. The instruction screen SC1 displays, separately from the first instruction part P110A of “view more”, a second instruction part P110B for displaying a second list screen SC2B showing a list of functions selected by the user among all functions. When the user has selected the first instruction part P110A, a flow of the list screen control unit 102 causing the user terminal 20 to display the first list screen SC2A is as explained in the embodiment. Note that, in the modification 13, the first instruction part P110A may not be included in the instruction screen SC1. The first instruction screen SC1 may not include the first instruction part P110A and may include the second instruction part P110B.

For example, it is assumed that selected function information concerning some functions selected by the user is stored in the database DB. When the user selects, from any screen, a function registered as a favorite, the server 10 generates selected function information indicating the function selected by the user and stores the selected function information in the database DB in correlation with a user ID of the logging-in user. The selected function information may be stored in another database other than the database DB. The instruction screen control unit 101 specifies, based on the selected function information, which function the user has selected. When a message is correlated with a function displayed on the second list screen SC2B, the instruction screen control unit 101 causes the user terminal 20 to display the instruction screen SC1 in which notification of the message is correlated with the second instruction part P110B.

Note that the modification 13 is different from the embodiment and the modifications 1 to 12 in that notification is correlated with not the first instruction part P110A but the second instruction part P110B but is the same as the embodiment and the modifications 1 to 12 in a method of correlating notification. For example, when the user selects the second instruction part P110B, as illustrated on the right side of FIG. 15, the list screen control unit 102 specifies, based on selected function information, a function selected by the user and causes the user terminal 20 to display the second list screen SC2B including an icon of the function and a message correlated with the function. The list screen control unit 102 only has to specify a message correlated with an individual function based on message information in the same manner as at the time of display of the first list screen SC2A.

The display control system 1 in the modification 13 causes the user terminal 20 to display the second list screen SC2B concerning a list of some functions selected by the user among all functions provided by an application. Accordingly, the user can notice, with notification (in the example illustrated on the left side of FIG. 3, the message “new arrival information is present”) correlated with the instruction part P110B, presence of a message correlated with a function not selected by the user even if the display control system 1 does not cause the user terminal 20 to display the second list screen SC2B. Therefore, the display control system 1 can improve the convenience of the user.

### [6-14. Modification 14]

For example, as explained in the modification 13, the instruction screen control unit 101 may cause the user terminal 20 to display the instruction screen SC1 including the first instruction part P110A for the user to instruct display of the first list screen SC2A concerning a list of all functions and the second instruction part P110B for the user to instruct display of the second list screen SC2B concerning a list of some functions. When the user has selected the first instruction part P110A, the list screen control unit 102 causes the user terminal 20 to display the first list screen SC2A. When the user has selected the second instruction part P110B, the list screen control unit 102 causes the user terminal 20 to display the second list screen SC2B.

The instruction screen control unit 101 in a modification 14 may cause the user terminal 20 to display the instruction screen SC1 in which first notification that is notification correlated with the first instruction part P110A and second notification that is notification correlated with the second instruction part P110B do not overlap. The first notification and the second notification not overlapping has a meaning including both of contents of the kinds of notification not overlapping and functions corresponding to the kinds of displayed notification not overlapping.

For example, the instruction screen control unit 101 determines first what is displayed as the second notification and determines what is displayed as the first notification such that the first notification is different from the second notification. Besides, for example, the instruction screen control unit 101 may determine, according to in which position each individual function is displayed, what is displayed. For example, the instruction screen control unit 101 may perform management for correlating a function designated as a favorite by the user with the second instruction part P110B and correlating another function other than the function present in the favorite among functions present in the list screen SC2 with the first instruction part P110A. The instruction screen control unit 101 causes the user terminal 20 to display the instruction screen SC1 in which the second notification is correlated with the second instruction part P110B and the first notification determined such that content different from the second notification is displayed is correlated with the first instruction part P110A.

The display control system 1 in the modification 14 causes the user terminal 20 to display the instruction screen SC1 in which the first notification that is the notification correlated with the first instruction part P110A and the second notification that is the notification correlated with the second instruction part P110B do not overlap. Accordingly, the user can check larger number of kinds of notification. Therefore, the display control system 1 can further improve the convenience of the user.

### [6-15. Modification 15]

For example, in the embodiment, the example is explained in which, when the instruction part P110 has been selected, the list screen SC2 different from the instruction screen SC1 is displayed. The instruction screen control unit 101 may cause the user terminal 20, which stores an application for providing a plurality of functions to the user, to display the instruction screen SC1 including some functions among the plurality of functions and the instruction part P110 for the user to instruct display of another function. In a modification 15, a function, an icon of which is displayed on the instruction screen SC1 that is certain one screen, is switched by selection of the instruction part P110.

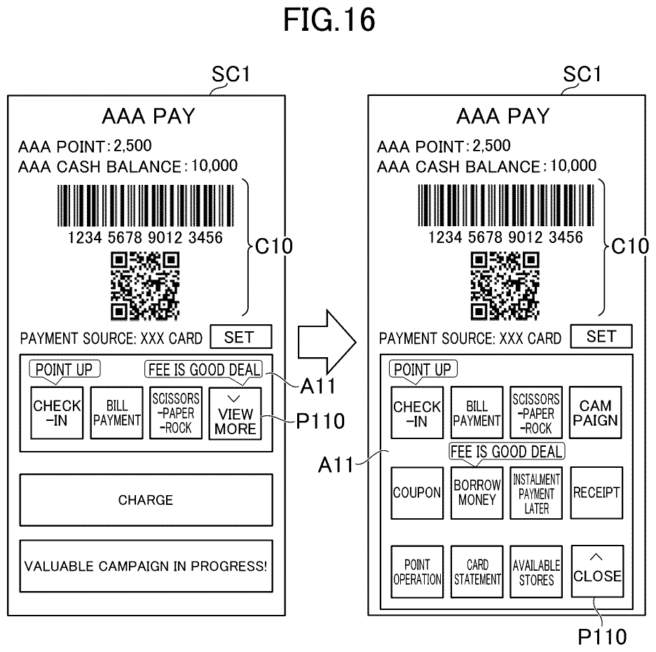

FIG. 16 is a diagram illustrating a screen example of an application in the modification 15. As illustrated on the left side of FIG. 16, before the instruction part P110 is selected, the instruction screen control unit 101 causes the display region A11 to display only icons of some functions among a plurality of functions. A method of displaying the instruction screen SC1 in this state may be the same as the methods explained in the embodiment and the modifications 1 to 14. On the left side of FIG. 16, an example is explained in which the number of icons in the display region A11 is smaller than the number of icons in the embodiment and the modifications 1 to 14. The number of icons in the display region A11 may be the same as the number of icons in the embodiment and the modifications 1 to 14 or may be larger than the number of icons in the embodiment and the modifications 1 to 14.

In the modification 15, a behavior of the user after selecting the instruction part P110 is different from the behavior in the embodiment and the modifications 1 to 14. For example, when the instruction part P110 has been selected, as illustrated on the right side of FIG. 16, the instruction screen control unit 101 causes the instruction screen SC1 to display another function (for example, another function, an icon of which is not displayed in the display region A11). That is, when the user selects the instruction part P110, an icon of a function not displayed to that point is displayed such that the display region A11 opens. The character string included in the instruction part P110 may be changed from “view more” to “close”. When the user selects the instruction part P110 in a state on the right side of FIG. 16, the instruction screen control unit 101 returns the instruction screen SC1 to the state on the left side of FIG. 16.

For example, when a message concerning another function is present, the instruction screen control unit 101 causes the user terminal 20 to display the instruction screen SC1 in which the message is correlated with the instruction part P110 as illustrated on the left side of FIG. 16. The instruction screen control unit 101 determines, based on the message information stored in the database DB, whether a function with which a message is correlated is present. When not determining that a function with which a message is correlated is present, the instruction screen control unit 101 does not correlate the message with the instruction part P110. When determining that a function with which a message is correlated is present, the instruction screen control unit 101 correlates the message with the instruction part P110.

In an example illustrated on the left side of FIG. 16, the instruction screen control unit 101 causes the user terminal 20 to display the instruction screen SC1 in which the message “fee is a good deal” correlated with the cashing function is correlated with the instruction part P110. In the modification 15, when a plurality of functions with which messages are correlated are present, as in the modifications 2 to 6, the instruction screen control unit 101 may cause the user terminal 20 to display the instruction screen SC1 in which a message of a function satisfying a predetermined condition is correlated with the instruction part P110 as notification. Besides, for example, at least one of the modifications 7 to 14 and the modification 15 may be combined. In the modifications 7 to 14, the display control for the instruction screen SC1 can also be applied to display control for the instruction screen SC1 in the modification 15.

The display control system 1 in the modification 15 causes the user terminal 20 to display the instruction screen SC1 including some functions among a plurality of functions and the instruction part P110 for the user to instruct display of another function. When the instruction part P110 has been selected, the display control system 1 causes the user terminal 20 to display the other function on the display screen SC1. When a message concerning the other function is present, the display control system 1 causes the user terminal 20 to display the instruction screen SC1 in which the message is correlated with the instruction part P110. Accordingly, the user can notice, with the message (in the example illustrated on the left side of FIG. 16, the message “fee is a good deal”) correlated with the instruction part P110, presence of a function with which the message is correlated even if the display control system 1 does not cause the user terminal 20 to display the list screen SC2. Therefore, the display control system 1 can improve the convenience of the user.

### [6-16. Other Modifications]

For example, the modifications explained above may be combined.

For example, the functions explained as being implemented by the server 10 may be implemented by the user terminal 20 or another computer. The functions explained as being implemented by the server 10 may be shared by a plurality of computers. The functions explained as being implemented by the user terminal 20 may be implemented by the server 10 or another computer. The functions explained as being implemented by the user terminal 20 may be shared by a plurality of computers.

### [7. Notes]

For example, the display control system can also take configurations explained below.

(1)

A display control system including:
an instruction screen control unit configured to cause a user terminal, which stores an application for providing a plurality of functions to a user, to display an instruction screen including an instruction part for the user to instruct display of a list screen concerning a list of the plurality of functions; and
a list screen control unit configured to, when the instruction part has been selected, causes the user terminal to display the list screen, wherein
when the function with which a message to the user is correlated is present among the plurality of functions, the list screen control unit causes the user terminal to display the list screen in which the message is correlated with the function, and
when the function with which the message is correlated is present among the plurality of functions, the instruction screen control unit causes the user terminal to display the instruction screen in which notification concerning the message is correlated with the instruction part.
   (2)

The display control system described in (1), wherein the instruction screen control unit causes the user terminal to display the instruction screen in which the message is correlated with the instruction part as the notification.

(3)

The display control system described in (2), wherein
when a plurality of the functions with which the message is correlated are present, the list screen control unit causes the user terminal to display the list screen in which the message of the function is correlated with each of the plurality of functions, and
when a plurality of the functions with which the message is correlated are present, the instruction screen control unit specifies the function satisfying a predetermined condition among the plurality of functions and causes the user terminal to display the instruction screen in which the message of the function satisfying the predetermined condition is correlated with the instruction part.
   (4)

The display control system described in (3), further including a user attribute information acquiring unit configured to acquire user attribute information concerning an attribute of the user, wherein
the instruction screen control unit specifies, as the function satisfying the predetermined condition, the function corresponding to the user attribute information and causes the user terminal to display the instruction screen in which the message of the function corresponding to the user attribute information is correlated with the instruction part.
   (5)

The display control system described in (3) or (4), further including a user tendency information acquiring unit configured to acquire user tendency information concerning a tendency of the user estimated from a use state of an estimation service by the user, wherein
the instruction screen control unit specifies, as the function satisfying the predetermined condition, the function corresponding to the user tendency information and causes the user terminal to display the instruction screen in which the message of the function corresponding to the user tendency information is correlated with the instruction part.
   (6)

The display control system described in any one of (3) to (5), further including a use state information acquiring unit configured to acquire use state information concerning a use state of each of the plurality of functions by the user, wherein
the instruction screen control unit specifies, as the function satisfying the predetermined condition, the function corresponding to the use state information and causes the user terminal to display the instruction screen in which the message of the function corresponding to the use state information is correlated with the instruction part.
   (7)

The display control system described in any one of (3) to (6), wherein
the application is a settlement application for the user to use a settlement service,
the display control system further incudes a settlement information acquiring unit configured to acquire settlement information concerning settlement performed by the user from the settlement application, and
the instruction screen control unit specifies, as the function satisfying the predetermined condition, the function corresponding to the settlement information and causes the user terminal to display the instruction screen in which the message of the function corresponding to the settlement information is correlated with the instruction part.
   (8)

The display control system described in any one of (1) to (7), wherein the instruction screen control unit causes the user terminal to display the instruction screen in which information that can identify the function with which the message is correlated is correlated with the instruction part as the notification.

(9)

The display control system described in any one of (1) to (8), wherein, when a plurality of the messages are present, the instruction screen control unit causes the user terminal to display the instruction screen in which the notification of each of the plurality of messages is correlated with the instruction part.

(10)

The display control system described in any one of (1) to (9), wherein, when the instruction part has been selected, the list screen control unit causes the user terminal to display the list screen on which the function notified by the instruction screen is highlighted.

(11)

The display control system described in any one of (1) to (10), wherein, when a plurality of the messages are present, the instruction screen control unit causes the user terminal to display the instruction screen in which the notification concerning a number of the plurality of messages is correlated with the instruction part.

(12)

The display control system described in any one of (1) to (11), wherein
the instruction screen control unit causes the user terminal to display the instruction screen further including a selection part for the user to select some of the plurality of functions, and
when the message is correlated with the some functions, the instruction screen control unit causes the user terminal to display the instruction screen in which the message is correlated with the selection part.
   (13)

The display control system described in (12), wherein, when the message is correlated with another of the functions other than the some functions, the instruction screen control unit causes the user terminal to display the instruction screen in which the notification of the other function is correlated with the instruction part.

(14)

The display control system described in any one of (1) to (13), wherein the list screen control unit causes the user terminal to display the list screen concerning a list of some of the functions selected by the user among all the functions provided by the application.

(15)

The display control system described in (14), wherein
the instruction screen control unit causes the user terminal to display the instruction screen including a first instruction part for the user to instruct display of a first list screen concerning a list of all the functions and a second instruction part for the user to instruct display of a second list screen concerning a list of the some functions,
when the user has selected the first instruction part, the list screen control unit causes the user terminal to display the first list screen and, when the user has selected the second instruction part, the list screen control unit causes the user terminal to display the second list screen, and
the instruction screen control unit causes the user terminal to display the instruction screen on which first notification that is the notification correlated with the first instruction part and second notification that is the notification correlated with the second instruction part do not overlap.

What is claimed is:

1. A display control system comprising at least one processor:
causing a user terminal, which stores an application for providing a plurality of functions to a user, to display an instruction screen including an instruction part for the user to instruct display of a list screen concerning a list of the plurality of functions;
when the instruction part has been selected, causing the user terminal to display the list screen;
when the function with which a message to the user is correlated is present among the plurality of functions, causing the user terminal to display the list screen in which the message is correlated with the function; and
when the function with which the message is correlated is present among the plurality of functions, causing the user terminal to display the instruction screen in which notification concerning the message is correlated with the instruction part.

2. The display control system according to claim 1, comprising the at least one processor: causing the user terminal to display the instruction screen in which the message is correlated with the instruction part as the notification.

3. The display control system according to claim 2, comprising the at least one processor:
when a plurality of the functions with which the message is correlated are present, causing the user terminal to display the list screen in which the message of the function is correlated with each of the plurality of functions; and
when a plurality of the functions with which the message is correlated are present, specifying the function satisfying a predetermined condition among the plurality of functions and causing the user terminal to display the instruction screen in which the message of the function satisfying the predetermined condition is correlated with the instruction part.

4. The display control system according to claim 3, comprising the at least one processor:
acquiring user attribute information concerning an attribute of the user; and
specifying, as the function satisfying the predetermined condition, the function corresponding to the user attribute information and causing the user terminal to display the instruction screen in which the message of the function corresponding to the user attribute information is correlated with the instruction part.

5. The display control system according to claim 3, comprising the at least one processor:
acquiring user tendency information concerning a tendency of the user estimated from a use state of an estimation service by the user; and
specifying, as the function satisfying the predetermined condition, the function corresponding to the user tendency information and causing the user terminal to display the instruction screen in which the message of the function corresponding to the user tendency information is correlated with the instruction part.

6. The display control system according to claim 3, comprising the at least one processor:
acquiring use state information concerning a use state of each of the plurality of functions by the user; and
specifying, as the function satisfying the predetermined condition, the function corresponding to the use state information and causing the user terminal to display the instruction screen in which the message of the function corresponding to the use state information is correlated with the instruction part.

7. The display control system according to claim 3, wherein
the application is a settlement application for the user to use a settlement service, and
the at least one processor further comprises:
acquiring settlement information concerning settlement performed by the user from the settlement application; and
specifying, as the function satisfying the predetermined condition, the function corresponding to settlement information and causing the user terminal to display the instruction screen in which the message of the function corresponding to the settlement information is correlated with the instruction part.

8. The display control system according to claim 1, comprising the at least one processor causing the user terminal to display the instruction screen in which information that can identify the function with which the message is correlated is correlated with the instruction part as the notification.

9. The display control system according to claim 1, comprising the at least one processor, when a plurality of the messages are present, causing the user terminal to display the instruction screen in which the notification of each of the plurality of messages is correlated with the instruction part.

10. The display control system according to claim 1, comprising the at least one processor, when the instruction part has been selected, causing the user terminal to display the list screen on which the function notified by the instruction screen is highlighted.

11. The display control system according to claim 1, comprising the at least one processor, when a plurality of the messages are present, causing the user terminal to display the instruction screen in which the notification concerning a number of the plurality of messages is correlated with the instruction part.

12. The display control system according to claim 1, comprising the at least one processor:
causing the user terminal to display the instruction screen further including a selection part for the user to select some of the plurality of functions, and
when the message is correlated with the some functions, causing the user terminal to display the instruction screen in which the message is correlated with the selection part.

13. The display control system according to claim 12, comprising the at least one processor, when the message is correlated with another of the functions other than the some functions, causing the user terminal to display the instruction screen in which the notification of the other function is correlated with the instruction part.

14. The display control system according to claim 1, comprising the at least one processor causing the user terminal to display the list screen concerning a list of some of the functions selected by the user among all the functions provided by the application.

15. The display control system according to claim 14, comprising the at least one processor:
causing the user terminal to display the instruction screen including a first instruction part for the user to instruct display of a first list screen concerning a list of all the functions and a second instruction part for the user to instruct display of a second list screen concerning a list of the some functions; and
when the user has selected the first instruction part, causing the user terminal to display the first list screen and, when the user has selected the second instruction part, causing the user terminal to display the second list screen, and
causing the user terminal to display the instruction screen on which first notification that is the notification correlated with the first instruction part and second notification that is the notification correlated with the second instruction part do not overlap.

16. A display control method comprising:
causing a user terminal, which stores an application for providing a plurality of functions to a user, to display an instruction screen including an instruction part for the user to instruct display of a list screen concerning a list of the plurality of functions;
when the instruction part has been selected, causing the user terminal to display the list screen;
when the function with which a message to the user is correlated is present among the plurality of functions, causing the user terminal to display the list screen in which the message is correlated with the function; and
when the function with which the message is correlated is present among the plurality of functions, causing the user terminal to display the instruction screen in which notification concerning the message is correlated with the instruction part.

17. A non-transitory computer readable information storage medium storing a program for causing a computer to:
cause a user terminal, which stores an application for providing a plurality of functions to a user, to display an instruction screen including an instruction part for the user to instruct display of a list screen concerning a list of the plurality of functions;
when the instruction part has been selected, cause the user terminal to display the list screen;
when the function with which a message to the user is correlated is present among the plurality of functions, cause the user terminal to display the list screen in which the message is correlated with the function; and
when the function with which the message is correlated is present among the plurality of functions, cause the user terminal to display the instruction screen in which notification concerning the message is correlated with the instruction part.
